(19) United States
(12) Patent Application Publication
(10) Pub. No.: US 2012/0094153 A1
(43) Pub. Date: Apr. 19, 2012

(54) Cross Stripping for High-Rate Lithium Battery Cell Pack

(75) Inventor: Samuel Fuller, Sarasota, FL (US)

(73) Assignee: BRAILLE BATTERY, INC., Sarasota, FL (US)

(21) Appl. No.: 13/272,893

(22) Filed: Oct. 13, 2011

Related U.S. Application Data
(60) Provisional application No. 61/392,507, filed on Oct. 13, 2010.

(51) Int. Cl. H01M 2/10; B23P 11/00; H01M 2/12

(52) U.S. Cl. 429/53; 429/159; 29/428; 29/525.14

(57) ABSTRACT

A battery pack comprising a plurality of battery cells being positioned adjacent to one another in a series of rows including a first outer row and a second outer row, a first endcap strip connected to the first row, a second endcap strip connected to the second row, and a plurality of cross-member strips connected to adjacent rows, wherein the first endcap, second endcap, and plurality of cross-member strips join the plurality of battery cells in both parallel and series.

### CROSS-REFERENCE TO RELATED APPLICATION

This application claims priority to provisional application Ser. No. 61/392,507, filed Oct. 13, 2010, the entire contents of which is incorporated herein by reference.

### TECHNICAL FIELD

This disclosure relates to a high rate lithium cell battery pack. More specifically, this disclosure relates to a battery pack comprising a plurality of battery cells joined in both parallel and series.

### BACKGROUND OF THE INVENTION

Existing batteries used for Starting, Lighting, and Ignition (SLI) of the type to start internal combustion motors have typically been of flooded electrolyte or in recent years, absorptive glass-mat (AGM) technology. This type of battery is often found in automobiles, motorcycles, lawn and garden equipment, boats, and heavy equipment machinery. The most common form of these batteries are almost exclusively of prismatic designs into containers with partitions to define the cells. These cells are made of plates of lead or lead alloy grids of various designs, interconnected and connected with either top or side post terminals. These cells are flooded with electrolyte solutions with the container base thermally sealed to a top which has vents to allow for gases generated during the normal discharging and charging cycles. AGM designs forego the need for venting during normal cycling, but rely on venting during extreme situations of overcharging or discharging.

These batteries are often heavy due to the abundant use of lead in their construction. This weight within any transportation or mobile device affects the vehicles efficiency and performance. It also complicates the transportation of the battery to manufacturers and to consumers. Typical lead acid SLI batteries weigh as much as 35 kg in the BCI group 31 size.

Additionally these lead acid batteries give off gas toxic hydrogen during charge and discharge and require mounting outside of passenger compartments. As such, these batteries are most commonly found near the internal combustion engine where the battery is subjected to high temperatures and vibration which is known to shorten the life of the battery.

Due to the electrical characteristics of lead acid batteries in situations where high current draw rates are required over an extended period of time (more than momentary starting), without the alternator powering the SLI system, the batteries voltage will quickly fall below usable levels for components to perform required functions. This voltage sag during load requires vehicles to carry very large and heavy batteries to have enough reserve capacity to meet the needs of the vehicle. Hence, the alternator or charging system must always be in place to balance the needs of the system.

Advances in lithium ion battery technology have resulted in high rate battery cells in compact cylindrical formats. Lithium cells of various chemistries with increasing performance of common container sizes are known. Examples of this type of cell are found within patent applications such as Pub. No.: US 2008/169790 which focus on electrochemical and construction techniques to achieve high charge and high discharge rates. These discharge and charge rates may be multiples of the batteries capacity. For example, in some cells with amp ratings of a variable “C” the amperage realized can be 50C-100C or more. The recent advances in cell performance has exceeded the known state of the art prior to the inventions claimed herein, limiting the overall performance of previously designed batteries. In some cases cells which had the performance of 50C installed in previous designed resulted in products which may have only been capable of 5C actual usage, thereby rendering many of the improvements in cell design useless.

Modular battery designs have been patented using thin metal film, nickel cadmium, nickel metal hydride and lithium cells. These have provisions for multiple cell arrangements and methods to control the function, safety and usability of various designs. Existing modular or multi-cell packs rely on a single tab to connect each cell to another cell directly. These only run the single tab on the combination of series cells to raise voltage and rely on either a collecting of electrical current at a termination point or at a point away from the cells themselves, which causes the pack to easily become unbalanced when subjected to high charging or discharging rates.

In spite of the advancements in cell technology, packaging and electronics for various battery systems, the typical SLI battery remains large, heavy and is comprised of a flooded or absorbed electrolyte construction. This design has left little latitude of design for vehicle and product designers in reference to the SLI battery or high rate energy storage options.

Hence, there exists a need in the industry to overcome these problems and provide a battery design for high-rate lithium battery cells. As the chemistry of lithium cells continues to improve, improvements to the casing, connections and controls of lithium modules or packs exists.

### SUMMARY OF THE INVENTION

The present invention relates generally to electric storage batteries utilizing high rate secondary lithium batteries and more particularly, to providing direct high rate lithium battery packs with improved performance characteristics.

An advantage of one embodiment of the disclosure may be increased electrical performance over existing SLI or energy storage battery solutions. These electrical improvements include higher efficiency (less wasted energy) during charge and discharge, lower battery discharge during storage, increased peak and constant load performance with resultantly less voltage sag at any point in the state of charge.

Another advantage of one embodiment of the present disclosure may improve balancing of battery packs during both low discharge and high discharge rates.

Another advantage of one embodiment of the present disclosure may be improved high temperature performance and higher safety levels during operation or failure modes of the packs.

Another advantage of one embodiment of the present disclosure may be improved durability of battery packs when used in wide ranges of temperature, high vibration, high amperage, and other scenarios which have greater affect on existing designs.

Various embodiments of the disclosure may have none, some, or all of these advantages. Other technical advantages of the present disclosure may also be readily apparent to one skilled in the art.

### BRIEF DESCRIPTION OF THE DRAWINGS

For a more complete understanding of the present disclosure and its advantages, reference is now made to the following descriptions, taken in conjunction with the associated drawings wherein like reference numerals denote like elements and in which:

FIG. 1 illustrates a carbon case in accordance with the teachings of the present disclosure.

FIG. 2 illustrates an alternate embodiment of a carbon case in accordance with the teachings of the present disclosure.

FIG. 3 depicts a battery unit in accordance with the teachings of the present disclosure.

FIG. 4 illustrates a battery pack in accordance with the teachings of the present disclosure.

FIG. 4a illustrates a variety of combinations of battery packs in accordance with the teachings of the present disclosure.

FIG. 5 illustrates components of a lithium cell pack in accordance with the teachings of the present disclosure.

FIG. 5a illustrates a lithium cell and insulator in accordance with the teachings of the present disclosure.

FIG. 6 illustrates connecting strips in accordance with the teachings of the present disclosure.

FIG. 7 illustrates lithium pack grouping in accordance with the teachings of the present disclosure.

FIGS. 8a, 8b, & 8c illustrate various configurations of multiple lithium cell packs in accordance with the present disclosure.

FIG. 9 illustrates a cradle in accordance with the teachings of the present disclosure.

FIGS. 9a and 9b illustrate a battery pack in an alternate embodiment in accordance with the present disclosure.

FIGS. 9c, 9d, and 9e illustrate cradles in accordance with the teachings of the present disclosure.

FIGS. 10a and 10b illustrate side views of battery packs in accordance with the teachings of the present disclosure.

FIG. 11 is a side view of a direct connect battery connector in accordance with the teachings of the present disclosure.

FIG. 12 is two perspective views of a dual-mounting battery connector in accordance with the teachings of the present disclosure.

FIG. 13 is a perspective view of a lid, dual-mounting battery connectors and terminal posts in accordance with the teachings of the present disclosure.

FIG. 14 is a perspective view of a lid and three dual-mount battery connectors in accordance with the teachings of the present disclosure.

FIG. 15 is a view of direct-connect terminal posts in accordance with the teachings of the present disclosure.

FIGS. 16a and 16b are views of a terminal post installed in a battery case in accordance with the teachings of the present disclosure.

FIGS. 17a and 17b are views of a dual-mounting terminal block installed in a battery lid in accordance with the teachings of the present disclosure.

FIGS. 18a and 18b are further views of a dual-mounting terminal block in accordance with the teachings of the present disclosure.

FIG. 19 depicts a battery unit in accordance with the teachings of the present disclosure.

FIG. 20 depicts a lid with terminal vents in accordance with the teachings of the present disclosure.

FIG. 21 depicts a lid in accordance with the teachings of the present disclosure.

FIGS. 22a and 22b are views of the direct-connect terminal post installed in a battery case in accordance with the teachings of the present disclosure.

FIGS. 23a and 23b are views of a direct-connect terminal post installed in a battery case in accordance with the teachings of the present disclosure.

FIGS. 24a and 24b are views of a terminal post installed in a battery case in accordance with the teachings of the present disclosure.

FIG. 25 illustrates battery packs with and without a high current battery management system in accordance with the teachings of the present disclosure.

FIG. 26 illustrates a battery pack used in connection with a battery management information system in accordance with the teachings of the present disclosure.

FIG. 27 illustrates an external connection port or interface in accordance with the present disclosure.

FIG. 28 is a block diagram illustrating components of a battery management information system in accordance with the teachings of the present disclosure.

FIG. 29 is a block diagram illustrating components of a high current battery management system in accordance with the teachings of the present disclosure.

FIG. 30 is a further illustration of components of a high current battery management system in accordance with the teachings of the present disclosure.

FIG. 31 is an illustration of a battery unit in accordance with the teachings of the present disclosure.

### DETAILED DESCRIPTION OF THE DRAWINGS

A preferred embodiment of the present disclosure provides for utilization of high rate lithium chemistry batteries of various designs into a modular electrical storage battery capable of function as an SLI battery or electrical storage solution for other applications of both high or low charge/discharge rates. The disclosure may include both existing battery group sizes recognized by the battery counsel international (BCI) and sizes which are not recognized, but are currently existing or newly created which can benefit from the disclosure.

The disclosure may offer increased electrical performance over existing SLI or energy storage battery solutions. The design of the lithium cell pack 22, interconnects (also called connecting strips or straps), connects and terminals 32 and 34 are all of a very low-resistance alloy material and are designed to handle amperage rates relative to the total capacity of the completed disclosure beyond the 100C draw rate.

By using solid-state connections in some designs and high amperage mosfets the modular batteries may be able to transfer all of the available power from the pack 22 to the terminal post connections 32 and 34 with very little voltage drop or thermal rise.

As part of the disclosure, individual cells 24 may be joined by large alloy strips 28a, 28b, and 28c (discussed in detail below) both in parallel and series configurations. These large strips 28 join the series connection to whatever voltage is desired and may also directly connect multiple series of cells 24 to allow for more equalized balancing during both low and high rates of draw or charging. This may cure many of the balancing problems often associated with multi-cell batteries stringed into a parallel configuration. On a series configuration the use of low resistance high amperage interconnects also allows for each series to reach zero voltage at or near the same time, limiting the risk of a single series to be reversed in polarity. It also will allow for more precise regulation of pack voltage disconnects or management by lessening the number of electrical connections needed to meter voltage. In some cases this will allow for very large numbers of cells to be configured, with still minimal variation of voltages between parallel cells. Due to lower resistance between the series cells measurements of voltage at the battery terminals results in much higher accuracy than in designs which are not of this embodiment.

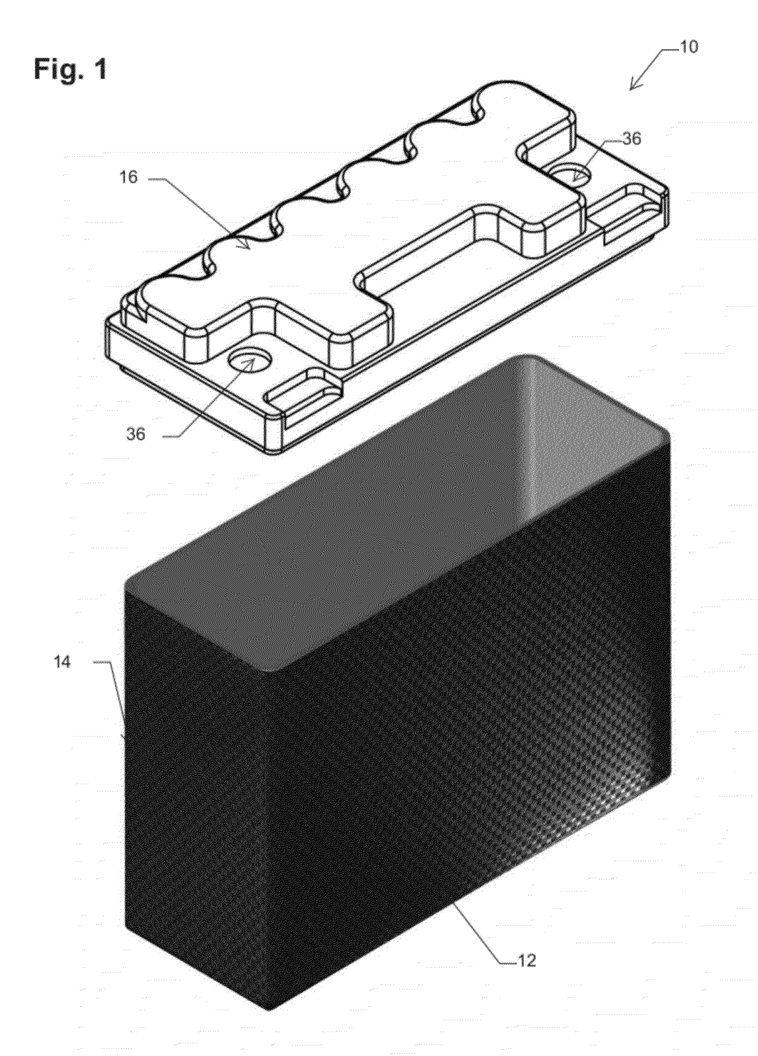

As shown in FIG. 1, the battery unit 10 preferably comprises a five-sided box comprising four wall members 14 and a bottom member 12. Preferably, the wall members 14 and bottom member 12 are made of a carbon resin casing or high temperature reinforced polymer or other suitable material. In instances where electrically conductive fibers are present within the composite a non-conductive layer of glass-fiber, kevlar, or other material may be used to prevent short circuiting of internal components. The design provides increased insulation from high ambient temperatures and vibration frequencies typically subjected to the battery cell packs 22 contained within. Using appropriate materials (such as carbon fiber) increases the container's ability to withstand and contain very high temperatures in the event of a rapid energy or heat release from the high rate lithium cells 24 contained therein (and discussed below). Direct contact may occur with some or all of the module within to allow for dissipation of thermal wattage in multiple scenarios.

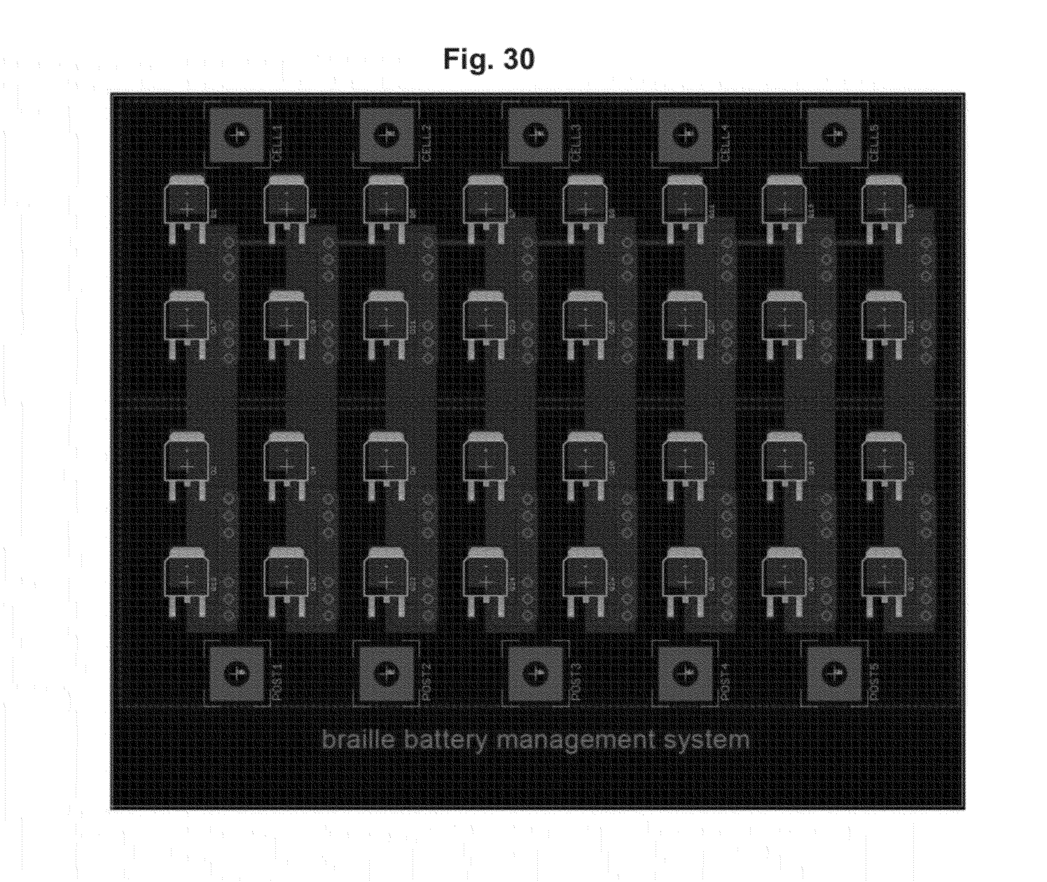

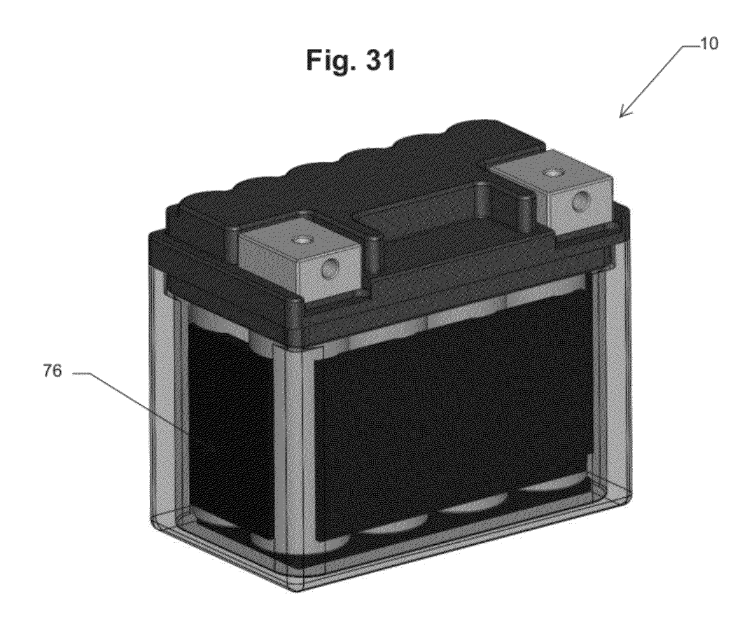

Additionally, an appropriate epoxy or laminate may be used on surfaces which can be subjected to high temperatures. For instance, a high temperature laminate adhesive may be provided underneath the lid 16 enabling the completed battery unit 10 to withstand significant temperatures (i.e. as high as 500° centigrade). Furthermore, padding 76 may be added inside the battery unit 10 to surround and cradle the battery cell packs 22. See FIG. 30. This padding 76 may preferably be encased in high-temperature resistant laminate or the like.

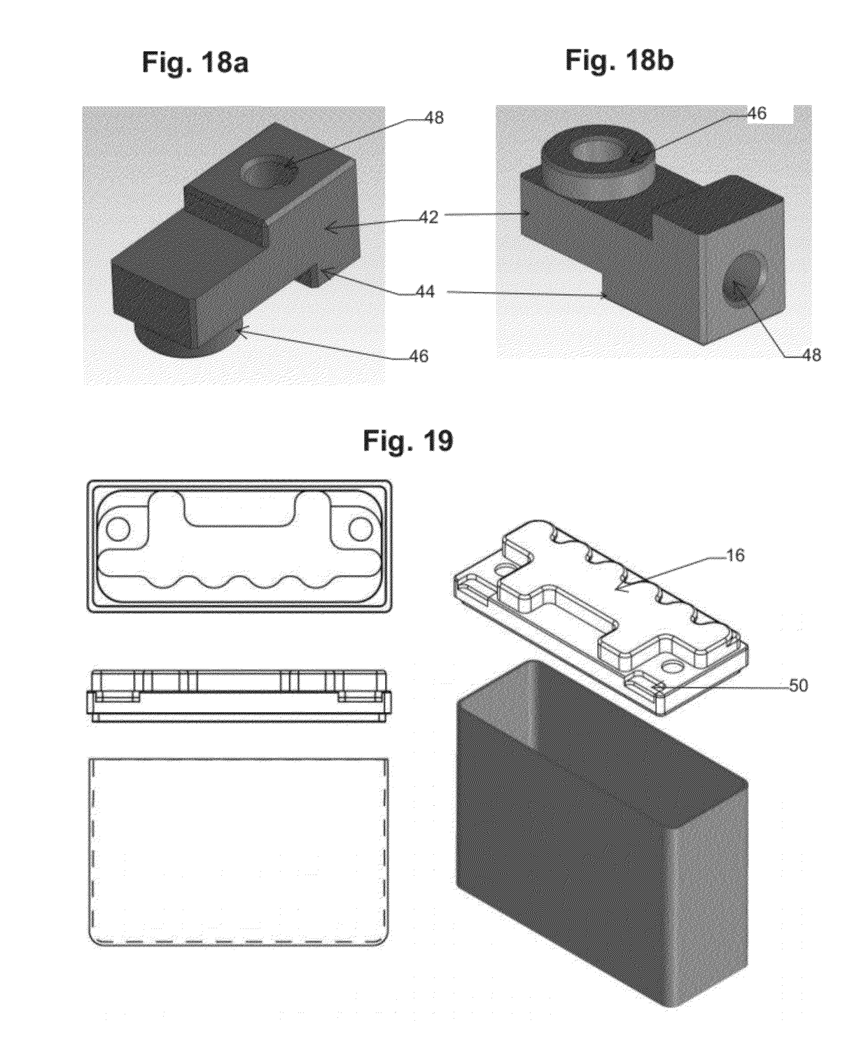

The battery unit 10 may further include an appropriately configured lid 16. The lid may preferably include venting ports (See FIG. 20). As mentioned above, the lid 16 interconnects with the wall members 14 of the carbon-fiber case so as to create an appropriate seal using a variety of construction methods such as ultrasonic welding, sealants, gaskets or the like. The lid 16 further includes post opening 36 to allow for terminal blocks (32 and 34 discussed below) to protrude through the lid 16 and enable a lower resistance connection (not depicted) with the battery cells 24 contained within the battery unit 10.

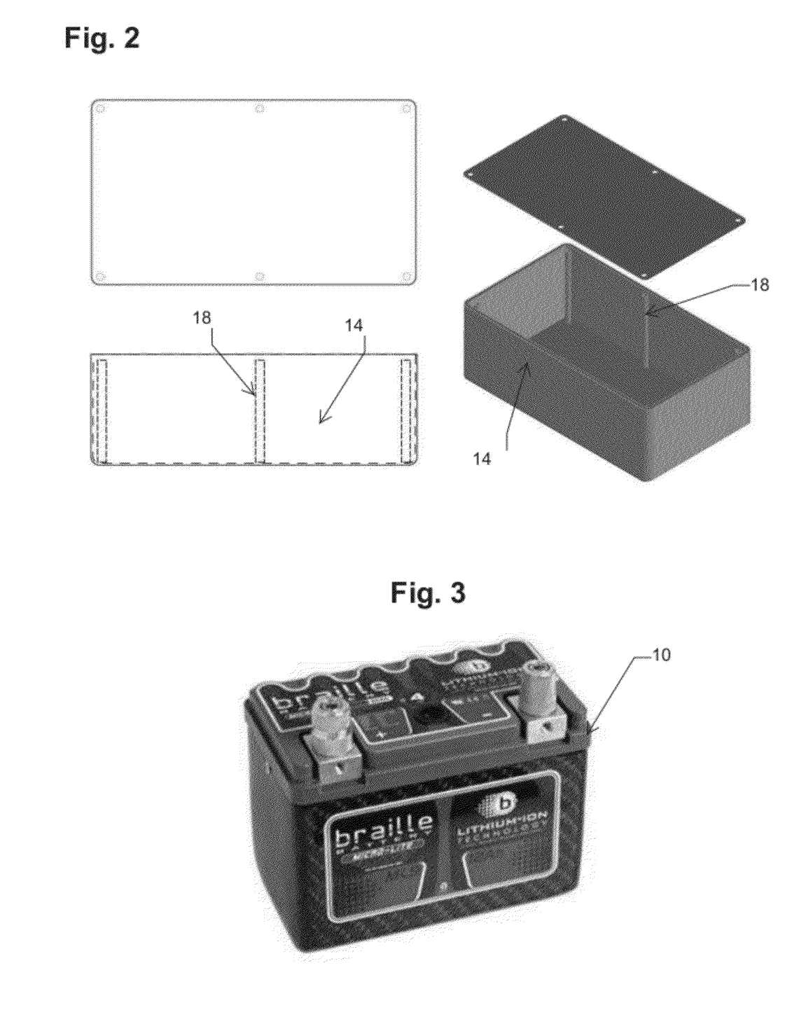

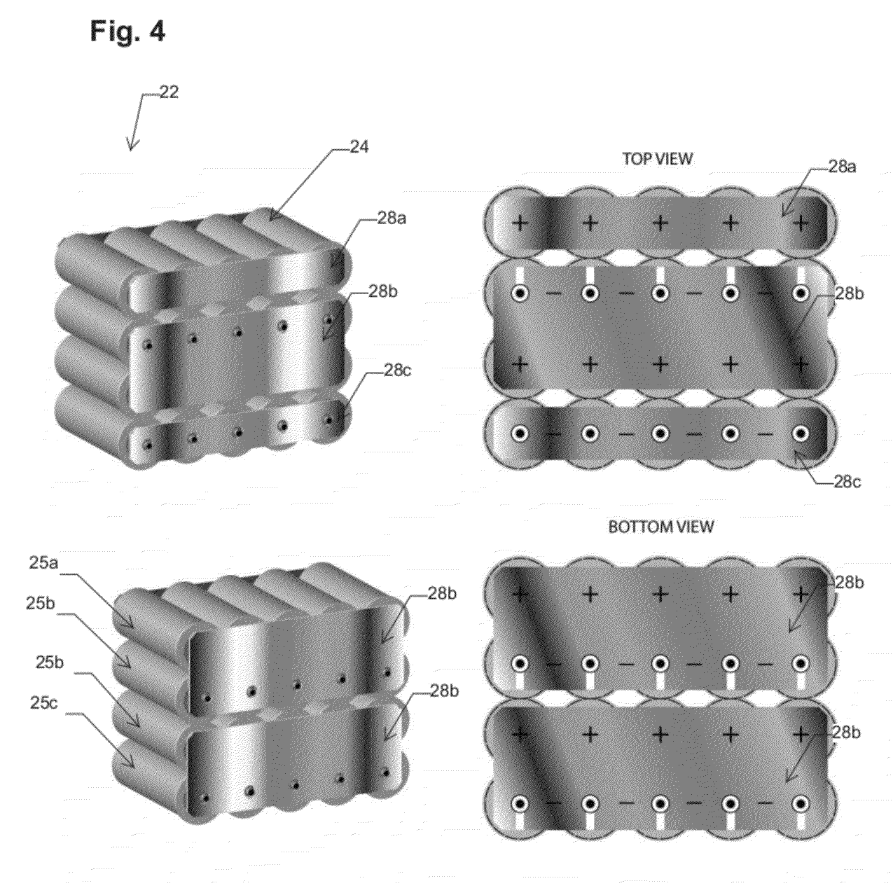

FIG. 2 depicts an alternate embodiment of the battery unit 10 disclosed herein. In such an embodiment, the battery unit 10 may include grooves 18 to assist in positioning and/or securing the battery cell packs 22 within the battery unit 10. These grooves may also serve as retention devices for fasteners or enclosure mounting points. FIG. 3 depicts a completed and sealed battery unit in accordance with one embodiment of the present disclosure.

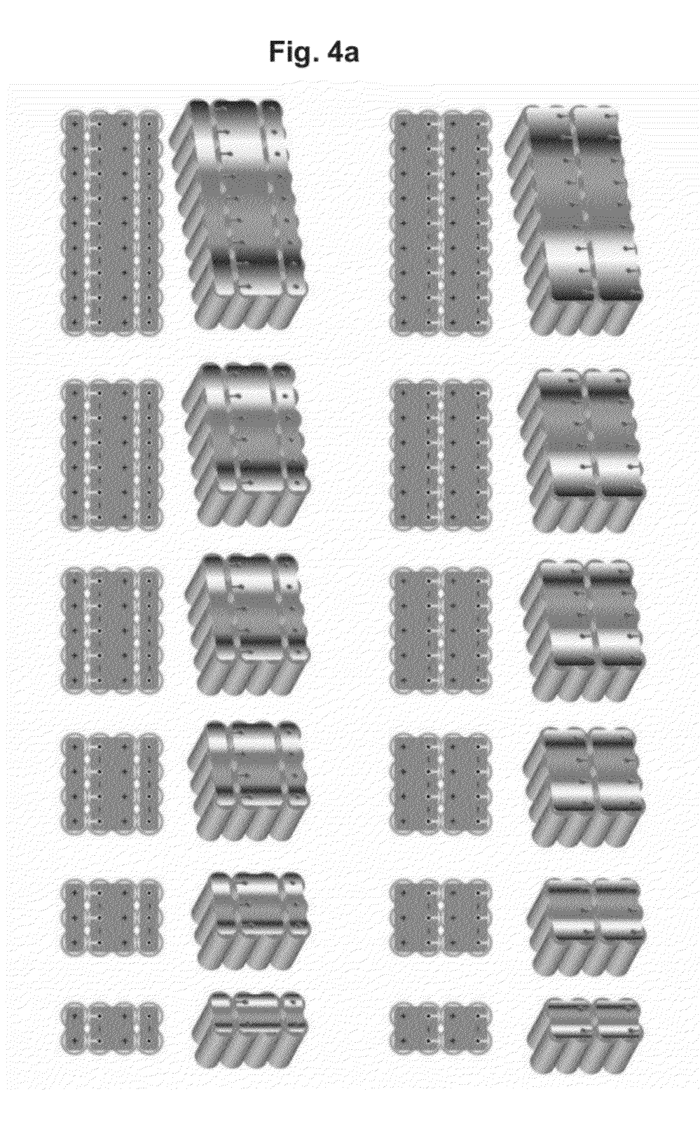

FIG. 4 depicts a lithium battery pack 22 in accordance with the present disclosure. The battery pack 22 comprises a plurality of high-rate lithium battery cells 24. Preferably, the cells 24 are pre-balanced by selecting cells with characteristics to match the design goals. For example, this design allows for specific performance characteristics to be accurately matched to performance specifications through standardization so that cells 24 in a pack 22 demonstrate similar characteristics. In this instance the life cycle, performance and calendar life of the products exceeds other methods of assembly without battery management and in some cases exceeds the performance of lithium cells with battery management systems. Different battery packs 22 are created with various configurations of cells 24 and strips 28 (discussed below) depending on the desired characteristics of the pack (i.e. voltage, current needs, capacity, etc.). In some cases battery cells with dissimilar capacities, impedance and chemistry of different manufacturers can be combined and utilized within known operational ranges to offer superior performance than could be realized by utilizing identical product. Knowledge of this technique can be further defined by the consistent and predictable method of assembly such as shown in module 22. In this instance some compromise among the characteristics of cells would be realized, but with gains in performance often above the mean average of what would be resulted through other methods of combining dissimilar cells.

The battery packs depicted in FIG. 4a are considered 4s or 4-series packs with a variety of parallel sets. Other configurations are within the scope of the present disclosure.

As shown in FIGS. 4-7, the high-rate lithium battery cells 24 are preferably interconnected both in series and in parallel via a number of strips 28. Additionally, a thermally and electrically adhesive backed insulator 26 may be placed between the battery cells 24 and the stripping 28. In other preferred embodiments, the insulator 26 may be placed in other locations of the battery to assist in controlling heat and insulate against electrical shorting. This insulator may be of a variety of thicknesses so as to allow or remove heat transfer from cells to straps. The coefficient of expansion of these materials may also be used to control certain electrical connection properties.

In a preferred embodiment, a battery pack 22 comprises a plurality of battery cells 24 being positioned adjacent to one another in a series of rows 25 including a first outer row 25a and a second outer row 25c, a first endcap strip 28a connected to the first row 25a, a second endcap strip 28c connected to the second row 25c, and a plurality of cross-member strips 28b connected to adjacent rows 25b, wherein the first endcap 28a, second endcap 28c, and plurality of cross-member strips 28b join the plurality of battery cells in both parallel and series.

Configuration of the battery packs 22 as disclosed herein may assist in holding the cells 24 in place during manufacturing. Further, the configuration can assist in limiting the vibration of the cells 24 during use of the battery unit 10. This is particularly important in SLI environments.

Furthermore, the configuration of the cells 24 as disclosed herein may be shaped to provide additional air flow between cells and insulate heat rise from the strip 28 to the outer cell.

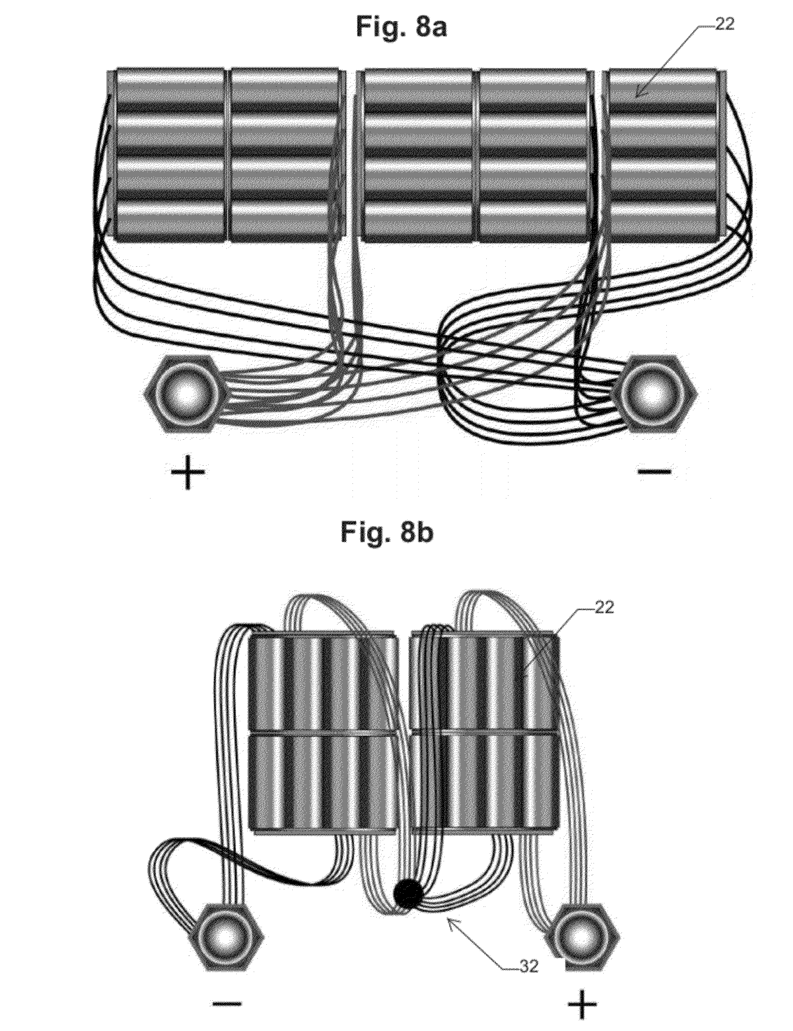

Returning to FIG. 4, the pack 22 preferably includes rows 25 of battery cells 24. The rows 25 are configured such that each battery cell 24 within the row 25 is aligned with one another so that all positive terminals are on one side and all negative terminals are on an opposite side. As shown in FIG. 4, each adjacent row is preferably positioned such that the positive terminals from one row are adjacent to the negative terminals of the adjacent row. It is also possible to align one or more rows in similar polarity and have equal or greater numbers of rows which are adjacent be of opposite polarity to build capacity or change the overall voltage of the pack. The rows 25 may be positioned adjacent one another as depicted in FIG. 4, or they may be positioned so that they overlap so as to conserve space as depicted in FIGS. 9a and 9b.

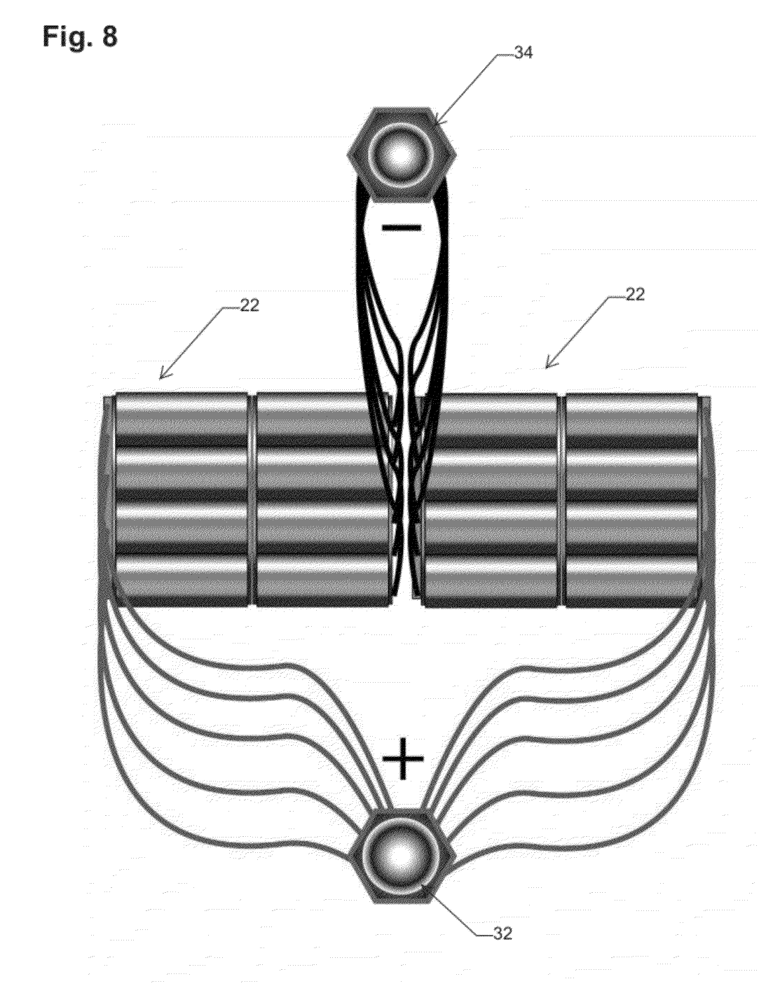

The rows 25 are interconnected with a plurality of strips 28. At the ends, there is a first endcap 28a and a second endcap 28c wherein the endcaps correspond to a positive and negative terminal respectively. As shown in FIG. 4, the first endcap 28a represents the positive terminal of the pack 22, while the second endcap 28c represents the negative terminal of the pack 22. FIG. 8 depicts these respective endcaps 28a and 28c interconnected to respective positive 32 and negative terminals 34.

The strips 28 are preferably made of a sheet of alloy material. In one embodiment, the cells 24 include a venting device 23, which may be located near the negative terminal of the cell 24 (or any other appropriate location). The endcap 28c corresponding to the negative terminal 34 may also include a plurality of holes 29. These holes are preferably configured to be aligned with the venting device 23 of the respective cells 24 to assist in safely venting excess pressure from the cell during failure of these cells due to abuse or damage of the pack 22.

The cross-member strips 28b may also include a plurality of holes 29 designed to be aligned with the respective cell venting devices 23 of the negative terminals. In a preferred embodiment, the holes 29 on the cross-member strips 28b may be in the form of a key hole slot, such as depicted in FIG. 4. The use of the key hole slot may assist with attaching the cross-member strips 28b to the cells 24 as discussed below. Generally, including voids in the strip 28 allows for ease in manufacturing and additional functional safety improvements. In manufacturing welds may occur on either side of the keyhole comprising of at least 8 weld points total on the cell, with at least 2 on each side of the key hole to retain equal resistance between cells within the pack. When laser welding is used these keyhole slots can provide additional seem joint surface for better connections and strength. The keyholes may also in some manufacturing methods be added to the straps on the polarity side which do not require a pathway for venting.

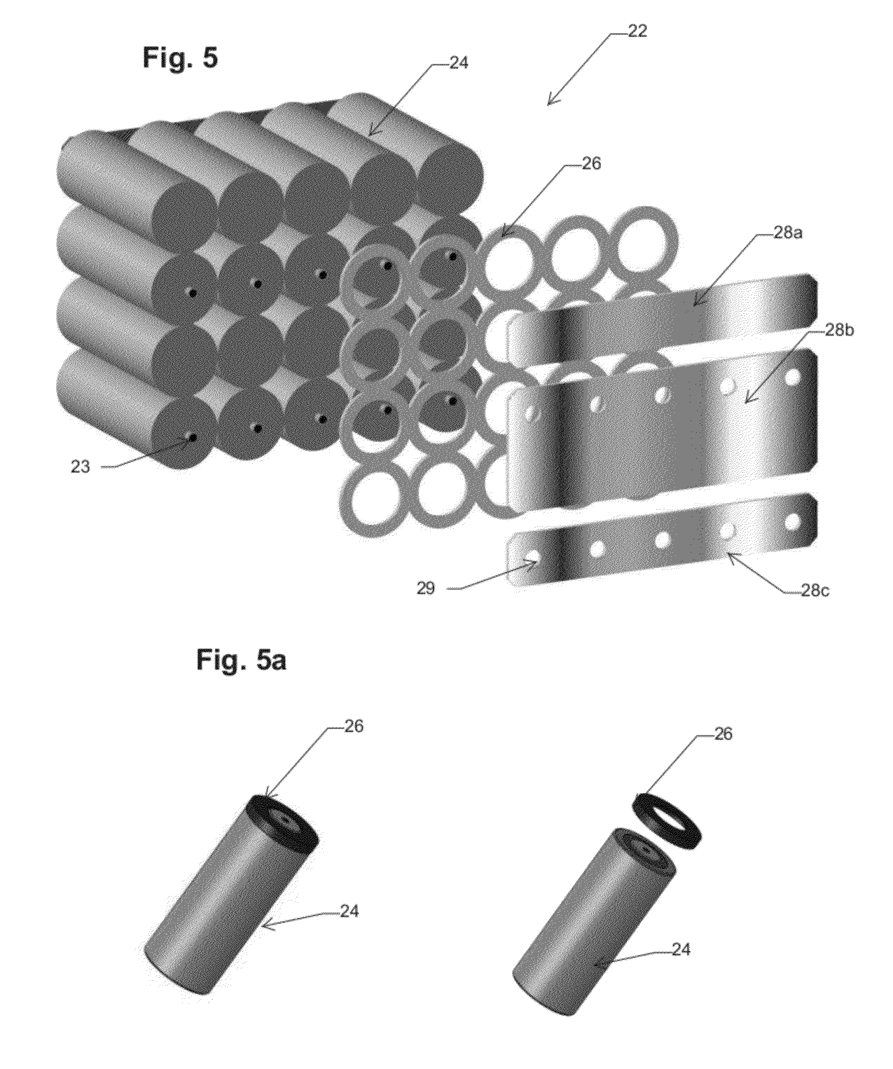

FIG. 5 provides another view of a pack 22 in accordance with the present disclosure. The pack 22 may further include an insulator 26. The insulator 26 may preferably be a plurality of circular-shaped members designed to connect with the respective battery cells 24. The design is preferably shaped so as to allow air flow between cells and insulate heat rise from the strip 28 to the outer cell wrap. While FIG. 5 depicts only a single insulator 26, numerous insulators 26 may be used. The insulator 26 may preferably include an adhesive to mount the insulator 26 to the battery cells 24. Alternatively, the insulator 26 may comprise individual components designed to engage with an individual cell 24 (See FIG. 5a).

The insulator 26 may serve numerous functions both in use and in manufacturing. In use, the insulator 26 may assist with heat control properties and to insulate against electrical shorting. The insulator 26 may also serve to protect against vibration during use of the pack 22. In manufacturing, the insulator 26 may be used to hold the cells 24 in place during manufacture.

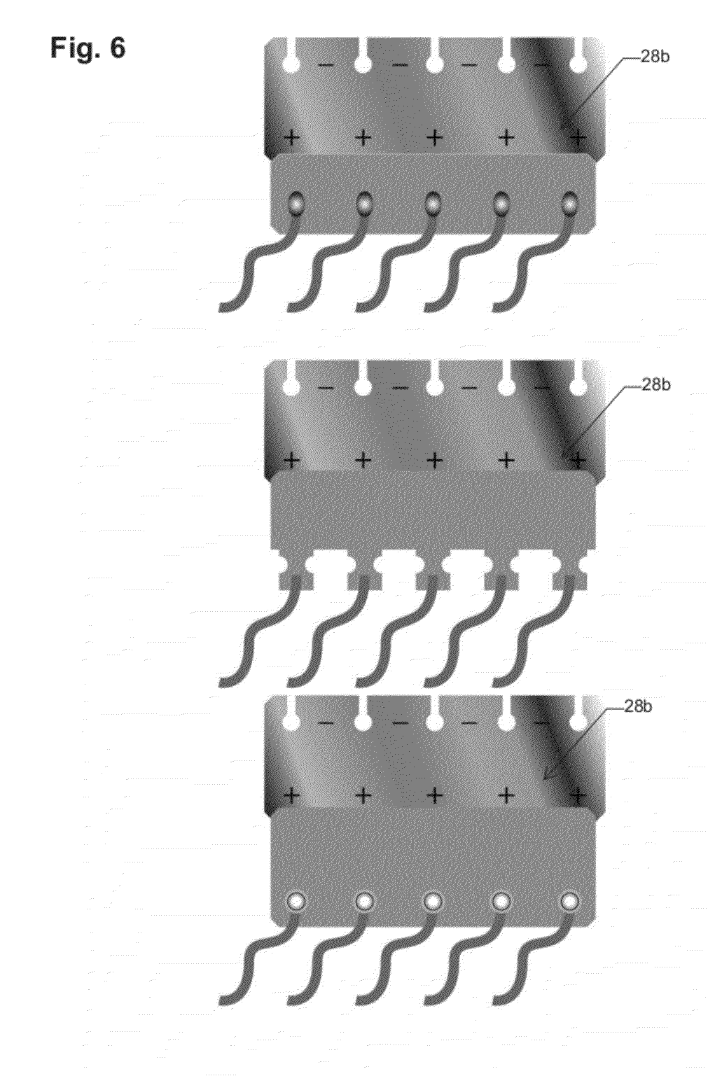

FIG. 6 depicts alternate embodiments of the cross-member stripping 28b disclosed herein. Preferably, the strips 28 comprise an alloy material which is connected via a direct contact to the terminals of the battery cells 24. In some embodiments, laser welding occurs around the vent hole (not depicted). Other cells 24 with under cap vending may have voids in the strip 28 to allow for manufacturing use, functional safety, and other benefits.

Additionally, welding by ultra-sonic or capacitive discharge method may be used. In one preferred embodiment, multiple contact or weld points (i.e. 6, 8, 10, 12, 14, 16, 20, or more weld points) may be used for increased strength and contact surface area. Another embodiment may also include positive pressure to hold the strip 28 in place by physical contact with the cradle 30, casing or container. Other methods of joining connections via adhesives, epoxies, strapping, or other methods may also be used.

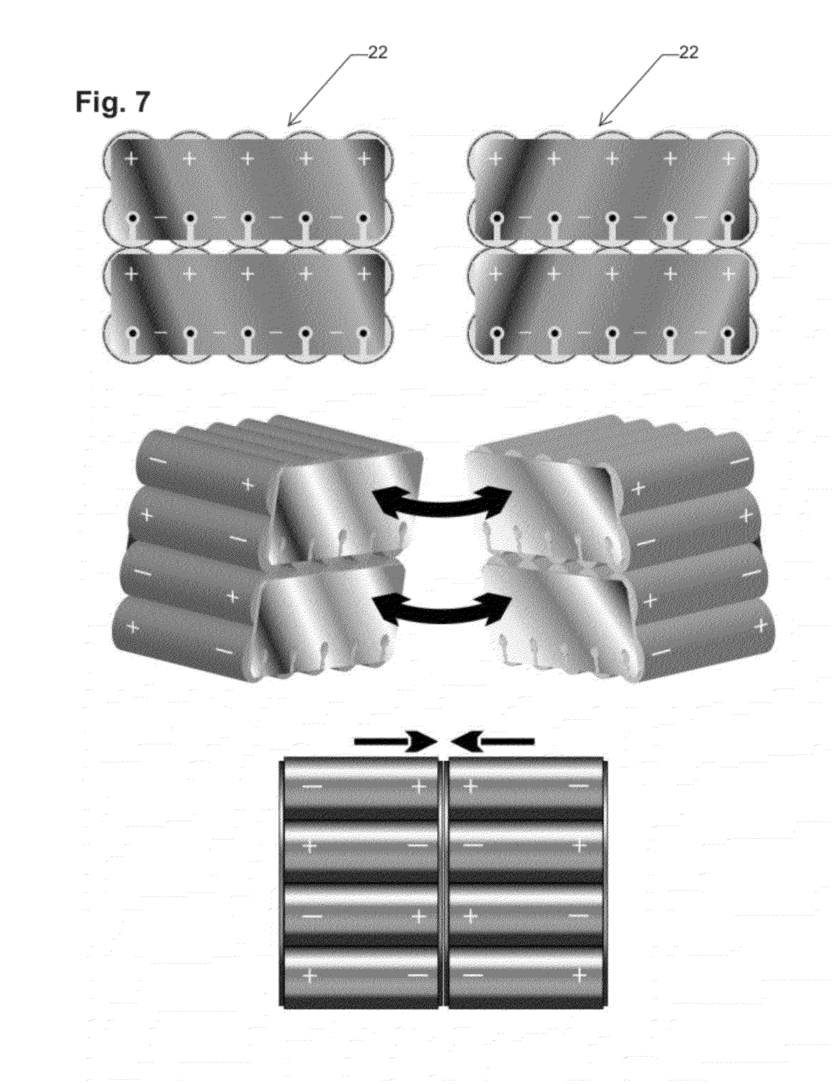

FIG. 7 depicts a combination of multiple battery packs 22 in accordance with the teachings of the present disclosure. Various alterations comprising packs of various voltages, performance and capacity could be configured in accordance with the teachings of the present disclosure. The connections and termination are all of a high current, low impedance design. Multiple packs 22 (as depicted in FIG. 7) may be housed independently. Alternatively, each pack 22 may be housed in a cradle 30 (discussed below). Alternatively, multiple packs 22 may be housed in a single cradle 30 (not depicted).

In another embodiment, multiple packs 22 may be connected by joining cells at similar polarities on the termination or non termination side, and pulling current from multiple points and methods. Increasing the contact points may achieve better balancing and high current flow with lower impedance. This type of joining may also be utilized for switching, sampling, or signaling (3S) iterations.

FIG. 8 depicts a wiring configuration of multiple packs 22 in accordance with the present disclosure. Preferably, flexible connections are attached to the allow strips 28 at a ratio of one connection per parallel series of cells (for example in a 4S5P pack 22 five wires would be used on the positive and five wires on the negative side), or in a relationship which yields the ability to carry all of the current efficiently from the pack 22. The flexible connections are preferably wiring sheathed with a high temperature coating to insulate the connections and contain thermal rise in high current settings. Preferably, all wires from the pack must have equal length or equal resistance to preserve cell balance and performance. Also, preferably location of these wires should be of equal distance from each other in relation also to the total length of the terminal strips.

The flexible connections terminate in a positive terminal 32 and a negative terminal 34. These terminals 32 and 34 protrude through the battery unit 10 lid 16 to enable the battery unit 10 to be used in standard SLI environments. Connection to the terminals is possible through manufacturing methods of direct soldering, crimping, welding, splicing and other methods. Each of these methods may be used to join the wires into devices such as ring terminals for the purpose of manufacturing and providing low resistance attachment points as further defined below.

A cradle 30 for use in accordance with the present disclosure is depicted in FIG. 9. Battery packs 22 may preferably be placed into a cradle 30 to assist with the structure of the battery, and may make up the interface between the outer dimension of the battery pack 22 and the inner dimension of the battery unit 10. Preferably, the cradle 30 is designed for energy release in a system failure of physical impact and allows proper cooling during high rate usage. Cradle 30 may also include heating elements.

The cradle 30 may also preferably be used during the manufacturing process, shipping process, storage, and handling of the packs 22. Furthermore, the cradle 30 may also serve as mounts for switching, sampling, or signaling (3S) devices or to contain or protect wiring.

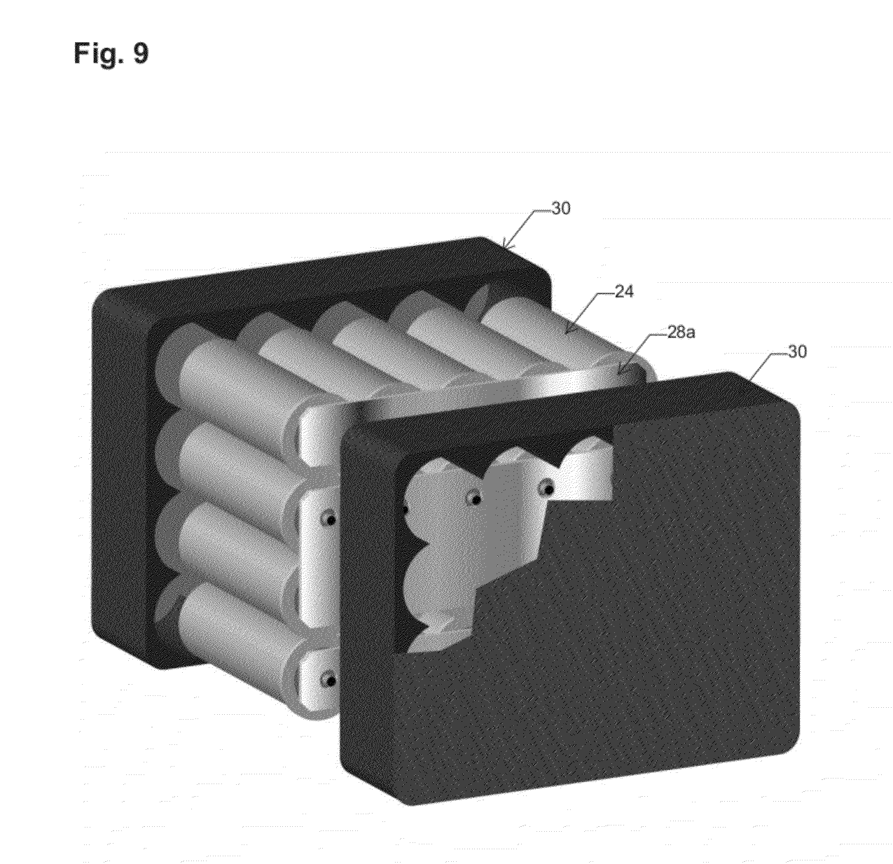

FIGS. 10a and 10b provide side views of packs 22 in accordance with the teachings of the present disclosure. FIG. 10a represents a pack 22 with four rows 25, while FIG. 10b shows a pack 22 with five rows 25. Each cell 24 depicted represents a row 25 of the pack 22. As shown, the first endcap 28a and second endcap 28c serve as termination points (which are preferably wired up to respective positive and negative terminals 34), while the adjacent rows are connected via cross-member strips 28b. Thus, each cell 24 in each row 25 is connected in parallel to one another, while each row 25 is connected in series to one another, creating a pack 22 whose cells 24 are joined in series and parallel.

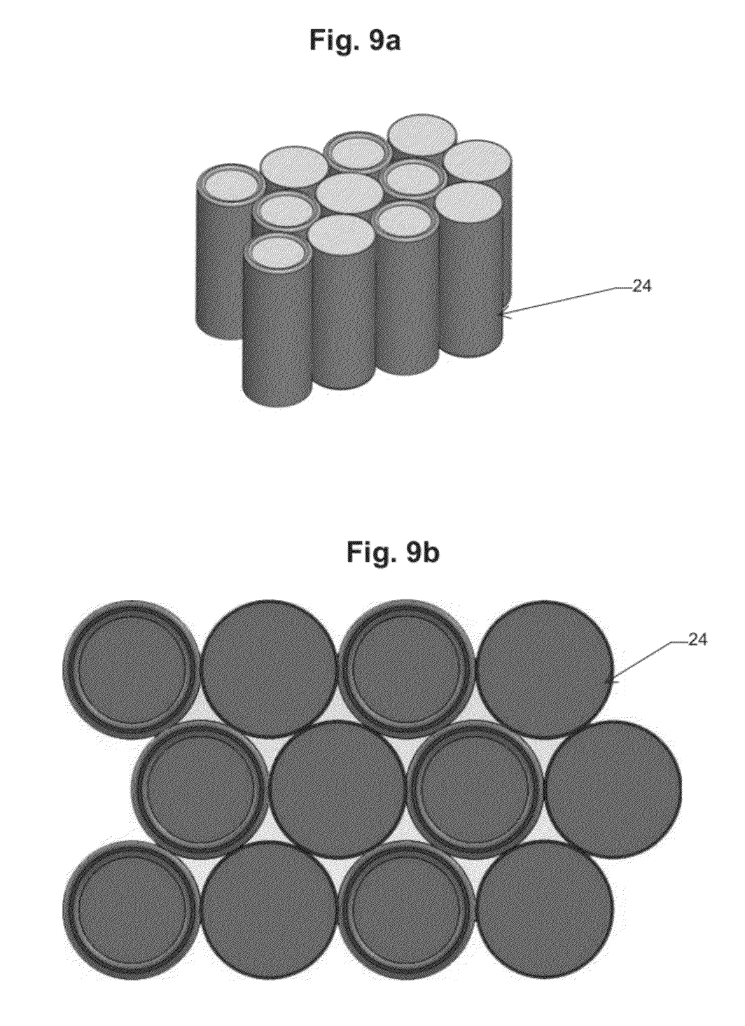

FIG. 11 depicts a side view of a direct-connect high-rate battery connector 40 in accordance with the teachings of the present disclosure. The connector 40 comprises a terminal post 58, and a bushing 68. In a preferred embodiment, the terminal post 58 and bushing 68 are both made from brass, copper, gold or other similar low resistance material.

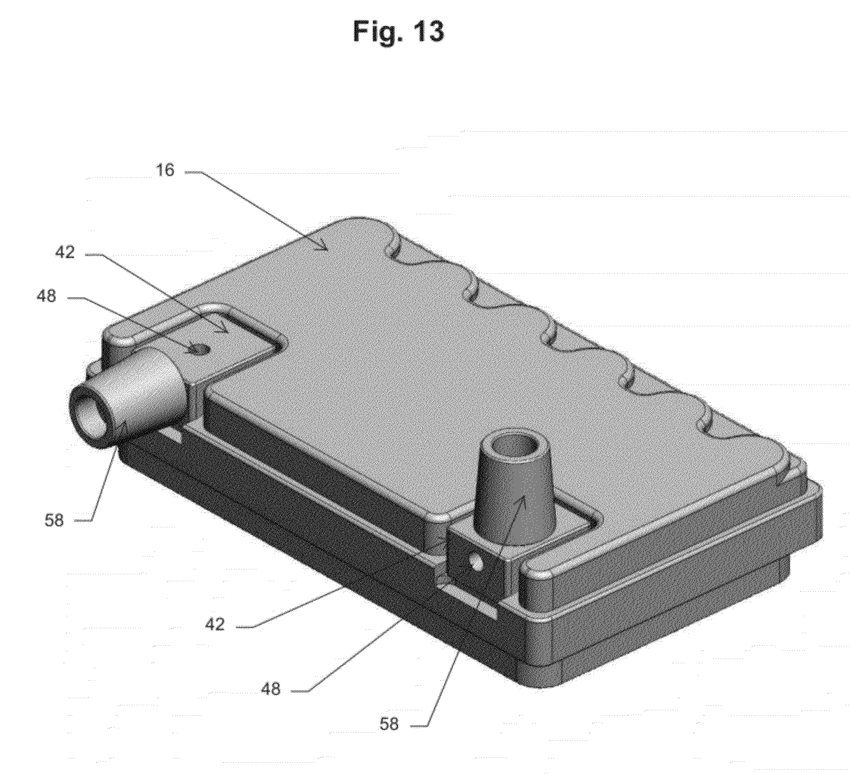

The terminal post 58 comprises a terminal post base 60, and an elongate member 62. The elongate member 62 is preferably designed to include an internal groove 72 for receiving a fastener 56. The elongate member 62 may also include knurling on an outer surface. This knurling provides increased pressure between the interface of the battery clamp as commonly used in SLI application and the post 58. As shown in FIG. 15, the knurling may be spaced so as to form a ring 70. Different configurations may be used, for instance using a single ring 70 to identify a positive terminal post 58, and two rings 70 to identify a negative terminal post. Preferably, the rings should be placed on the positive terminal in a ratio such that the actual contact surface on the smaller positive terminal 58 and the larger positive terminal are the same further equalizing the charge and discharge efficiency of the battery. Also, preferably the ring 70 may be equal to or recessed from the contact height of 58. The draft angle of these terminals may also respectively match the intended SLI interface or application connector so as to provide constant contact between terminal and vehicle (drain).

The terminal post base 60 may also include a series of teeth 66 on a bottom surface. These teeth 66 may aid in securing the terminal post 68 to the lid 16 by engaging into a top surface of the lid 16. The angle of these teeth 66 should preferably allow for tightening (clockwise) rotation of the terminal but resist loosening of the terminal in a counter-clockwise rotation. This also aids in manufacturing as the bottom bolt can be tightened in some cases without the need of a tool on the post base 60.

The connector 40 may also include a bushing 66 installed on an underside surface of the lid 16. Preferably, the bushing 66 protrudes through an opening 36 in the lid so that the top surface of the bushing rises above the opening 36 in the lid. The bushing 66 may also include an inner feature 72 so as to receive a fastener 56. In one preferred embodiment, the bushing 68 may also include a series of teeth 66 on a top surface so that the bushing may engage with an underside surface of the lid 16 to further provide support and stability. The total crush should preferably be calculated so that surfaces 66 bite into the material it passes through so that 68 and 58 mate together with 68 completely inserted into 58 giving electrical connection on the vertical and horizontal surfaces.

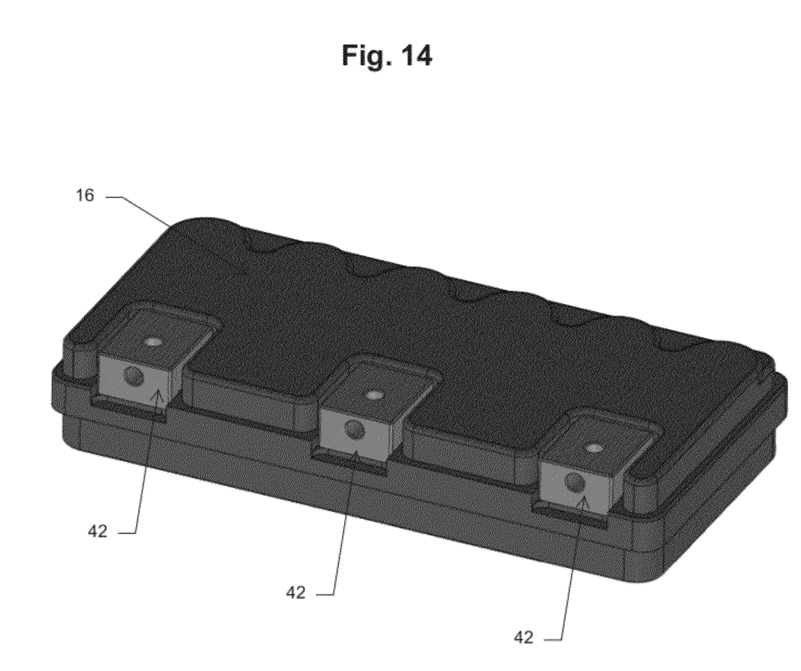

FIGS. 16a and 16b show additional detail for installing a connector 40 in accordance with the present disclosure. As shown, the connector 40 may be installed through the battery unit 10 case (as shown in FIGS. 16a & b). As depicted, the terminal post 58 is installed on an outside surface of the battery unit 10 and engages with the bushing 68, which is installed on an inside surface of the battery unit 10. The bushing 68 protrudes through the battery unit 10. Within the battery unit 10, an electrical connector 54 is affixed to the battery connector 40 utilizing an electrically conductive fastener 56, such as a bolt or the like. This electrical connector 54 may preferably be connected to a plurality of battery packs 22 as disclosed herein. The arrangement of the electrical connector from the pack should preferably connect directly to bushing 68 and the washer, bolt, or retention device such that heat and electrical energy can be transmitted efficiently into the terminal 58.

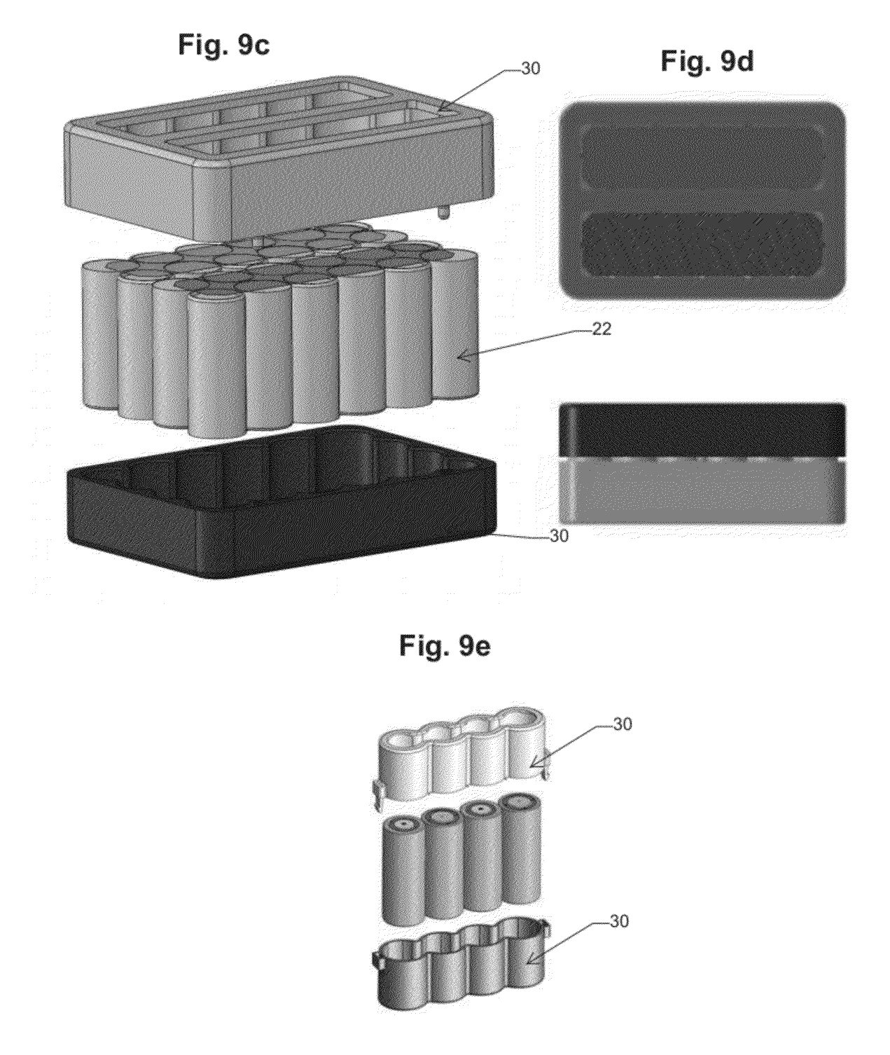

FIG. 12 depicts a dual-mounting terminal block 42 in accordance with the present disclosure. The dual-mounting terminal block 42 is preferably made of a brass or other similar material, and provides a large surface area to facilitate a direct high-rate connection between the battery cells 24 within the battery unit 10 and a load (not depicted). The dual mounting terminal block 42 preferably includes a mount 46 and a flange 44.

The mount 46 is preferably configured to sit securely within an opening 36 in the lid 16. The lid 16 may also preferably be designed to include a recess 50. This recess 50 may be configured to receive the flange 44. This recess 50 may offer a number of benefits, including a secure fitting for the dual-mounting terminal block 42. Additionally, by including a recess 50, the dual-mounting terminal block 42 preferably sits slightly within the confines of the edges of the lid 16. This may help avoid shorts and other incidents should the battery unit 10 be placed directly on a surface which might short out the unit. This also provides for safer shipping, handling, installation and storage of the product. Similarly, the top edge of the lid 16 may preferably be designed to extend beyond the dual mounting terminal block 42, so that the terminal block 42 sits underneath the top edge, for similar benefit.

The dual-mounting terminal block 42 also may include two terminal post openings 48. Preferably, the terminal post openings 48 are configured on perpendicular surfaces of the terminal block 42. Thus, terminal posts 58 may be installed in different configurations so as to permit various mounting configurations for the battery unit 10.

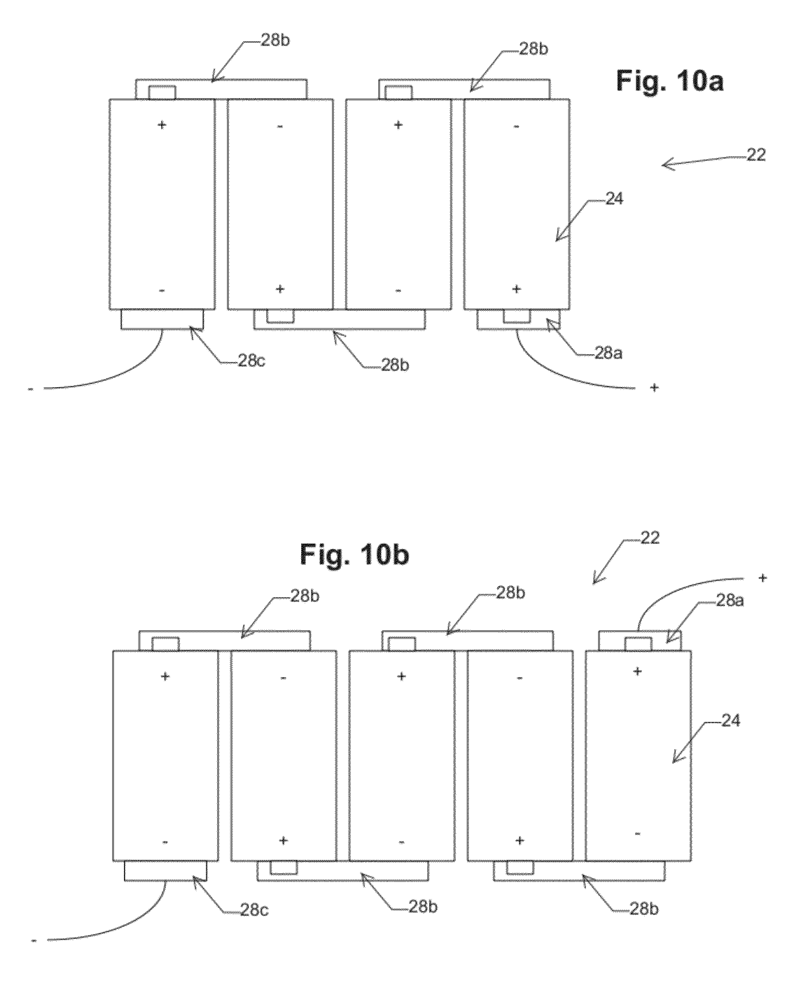

FIG. 13 depicts dual-mounting terminal blocks 42 in accordance with the present disclosure with the respective terminal posts 58 installed in perpendicular locations. When using the dual-mounting terminal block 42, it may also be preferable to use a terminal post 58 that does not include the teeth 66 depicted in FIG. 11. This is, in part, because the larger surface area of the dual-mounting terminal block 42 may not require the additional benefit of the teeth 66.

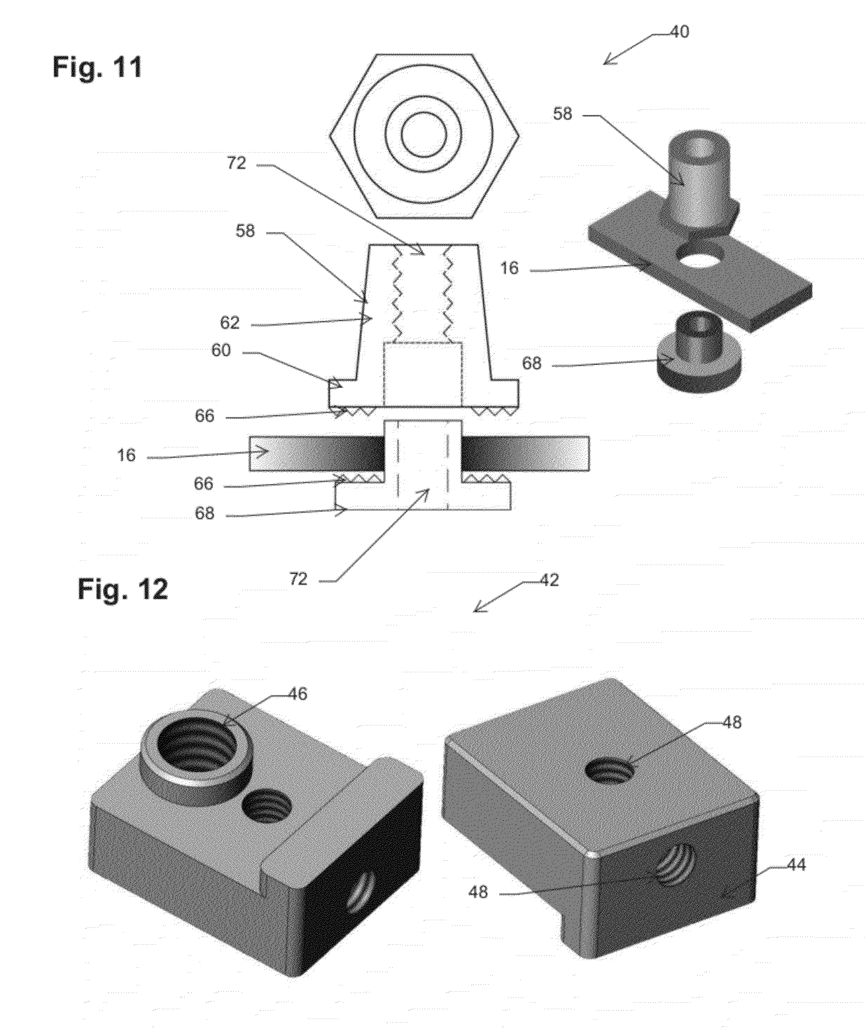

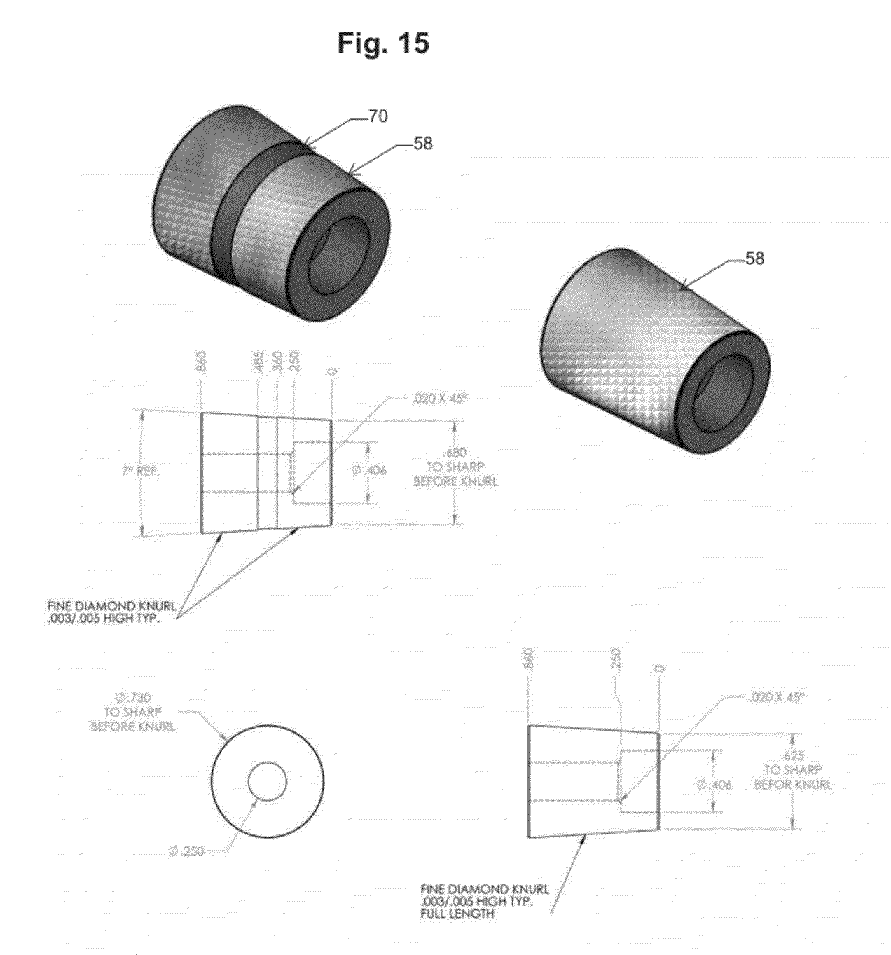

FIG. 14 depicts a lid 16 which may include various polarity options and configurations for receiving dual-mounting terminal blocks 42 in accordance with the present disclosure. This may allow for a variety of output connections, including multiple voltage ranges, for example 12 volt and 16 volts on the positive side. It may also allow for certain battery management features to be included or omitted from these specific terminals, for example under voltage or over voltage or current limitation on one of these terminals, with unrestricted voltage and current supply from the one of the additional terminals. FIGS. 17a and 17b provide additional detail for installing a dual-mounting terminal block 42 in accordance with the present disclosure. Note that the dual-mounting terminal block 42 may be utilized in different shapes. For instance, the dual-mounting terminal block in FIG. 12 is a wider configuration than depicted in FIGS. 17a & b. The former may be used in a motor sports type configuration (for instance race cars and automobiles), while the latter may be beneficial in a power sports configuration (for instance motorcycles).

FIG. 17a depicts the installation of the dual-mounting terminal block 42 from an underside surface of the lid 16, while FIG. 17b depicts the installation from above the lid. The dual-mounting terminal block 42 engages with the lid preferably via the flange 44. The flange 44 passes through an opening 36 in the lid and engages with an electrical connector 54 which is connected to the battery cell packs 22. An electrically conductive fastener 56 is then used to secure the dual-mounting terminal block 42 to the lid and electrical connector.

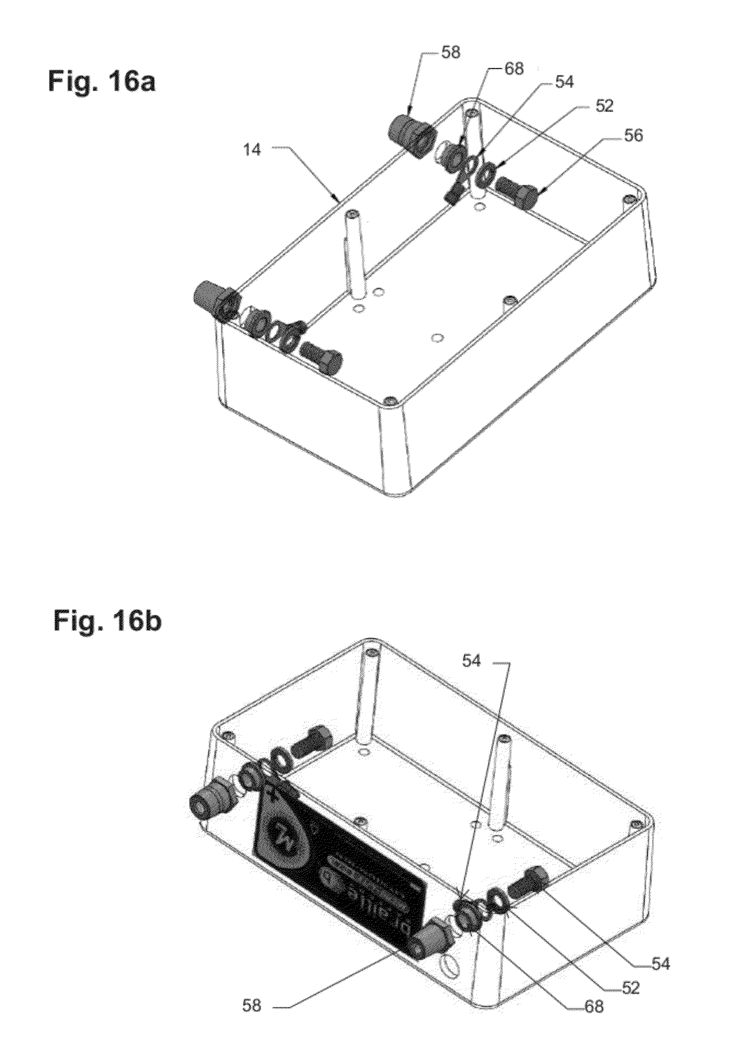

On top of the lid 16, the dual-mounting terminal block 42 sits within the recess 50 of the lid 16, providing two terminal post openings 48 for receiving terminal posts 58 in various configurations. FIGS. 18a and 18b show a closer view of the dual-mounting terminal block 42.

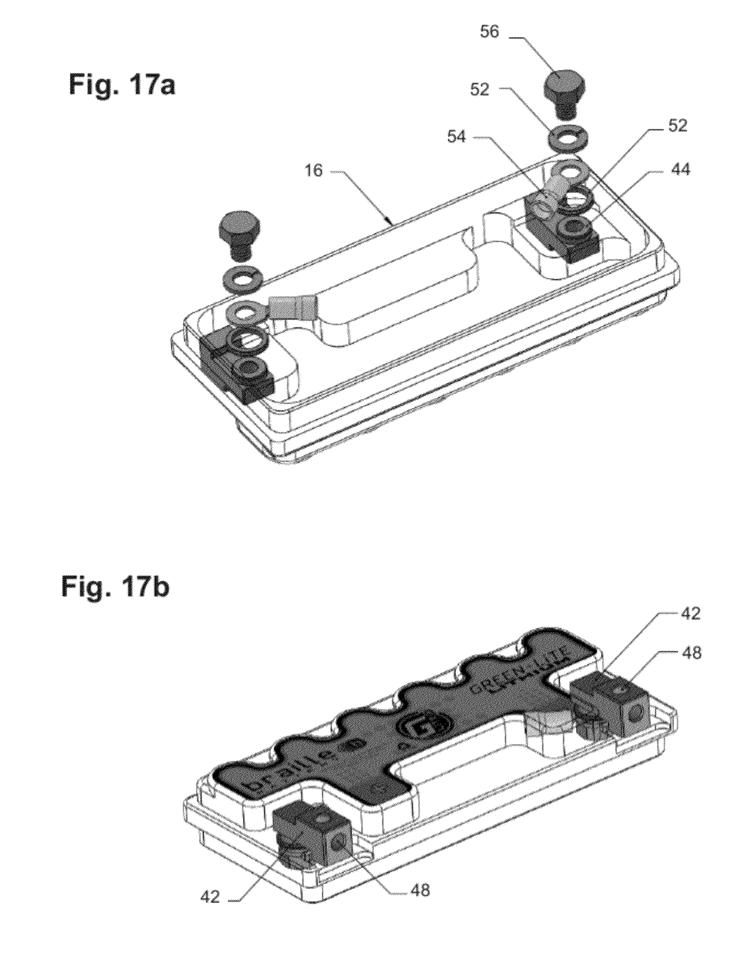

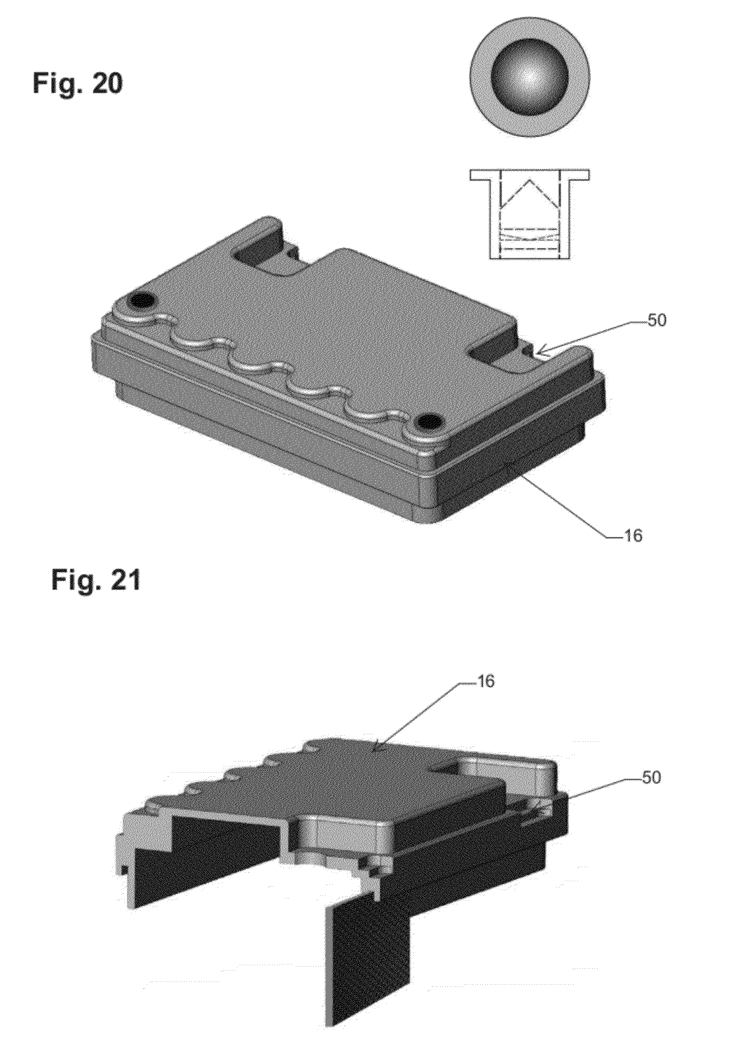

FIGS. 19, 20, and 21 show additional views of lids 16 that may be used in accordance with the present disclosure. As shown, the recess 50 is preferably designed to receive the dual-mounting terminal block 42 such that the mounting block 42 is not flush with any edge of the battery unit 10.

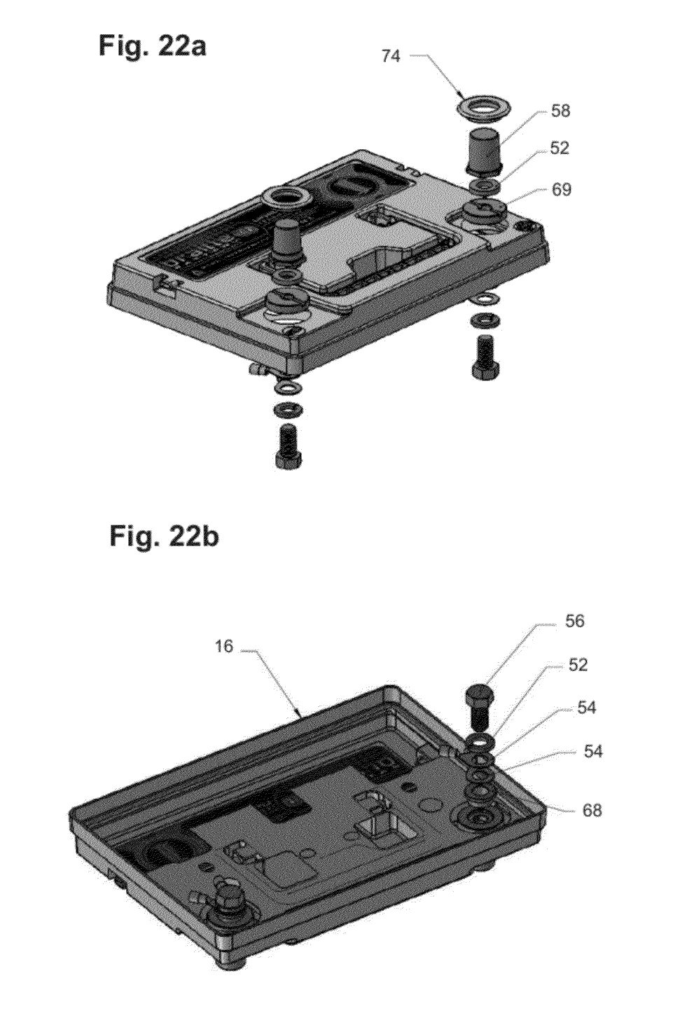

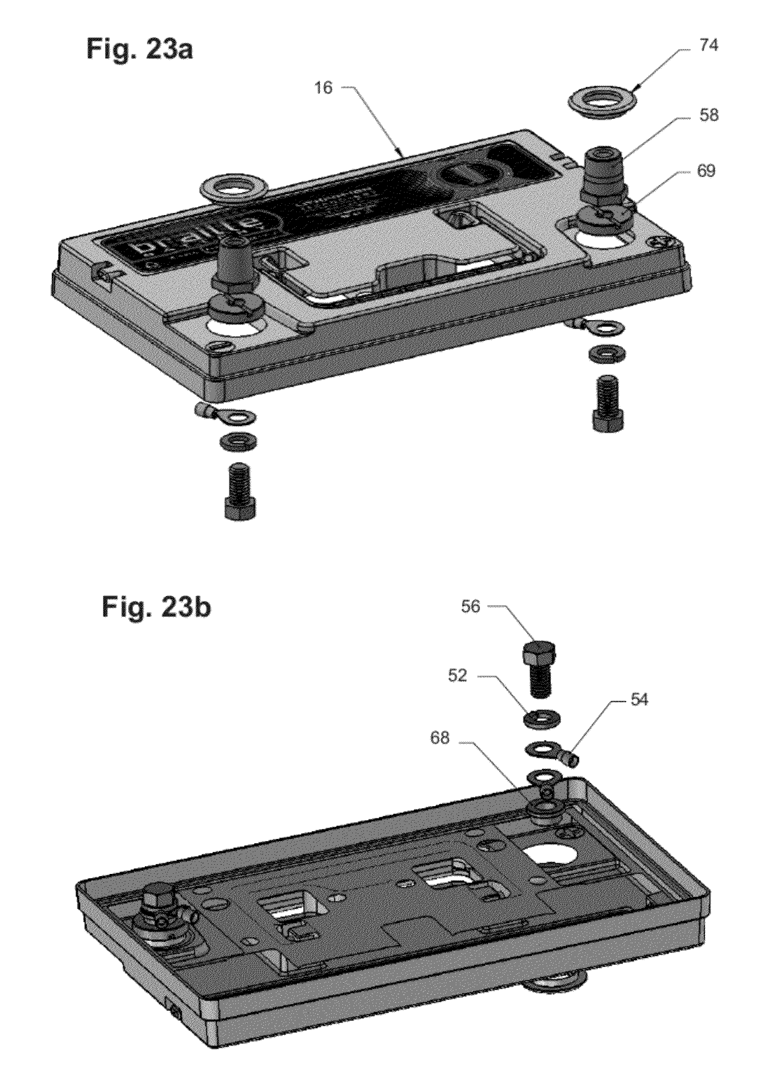

FIGS. 22, 23, and 24 depict alternate embodiments of a battery connector 40 in accordance with the teachings of the present disclosure. The battery connector 40 may include a debris ring 74 which may be used to affix around the terminal post 58 to prevent debris and other material from entering into the battery unit 10. This debris ring may also act as a water tight seal for marine or extreme environments. Further, the battery connector 40 may also include a mounting bushing 69, which may be used to further secure or install the battery connector 40. In one embodiment, the mounting bushing 69 includes a slit or other means used for providing leverage to aid in manufacturing the mounting bushing to the components under the lid 16. For instance, the embodiment depicted in FIGS. 22 and 23 may include a ledge within the recess 50 so that the mounting bushing 69 may sit on the ledge while still being contained within the recess 50.

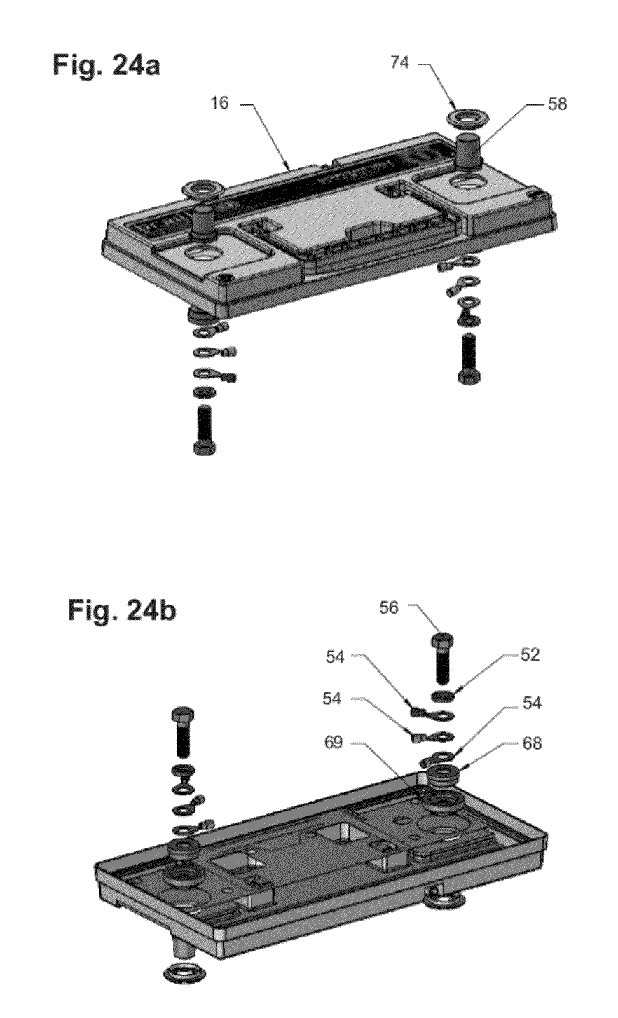

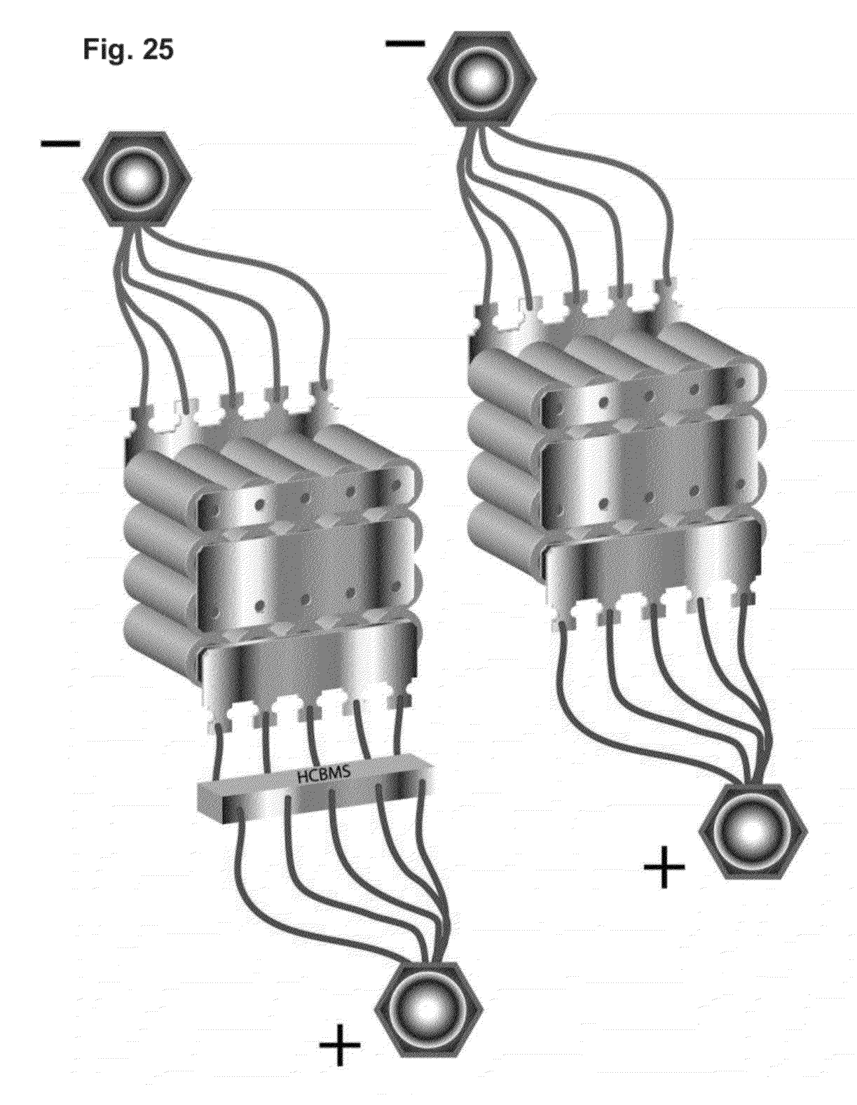

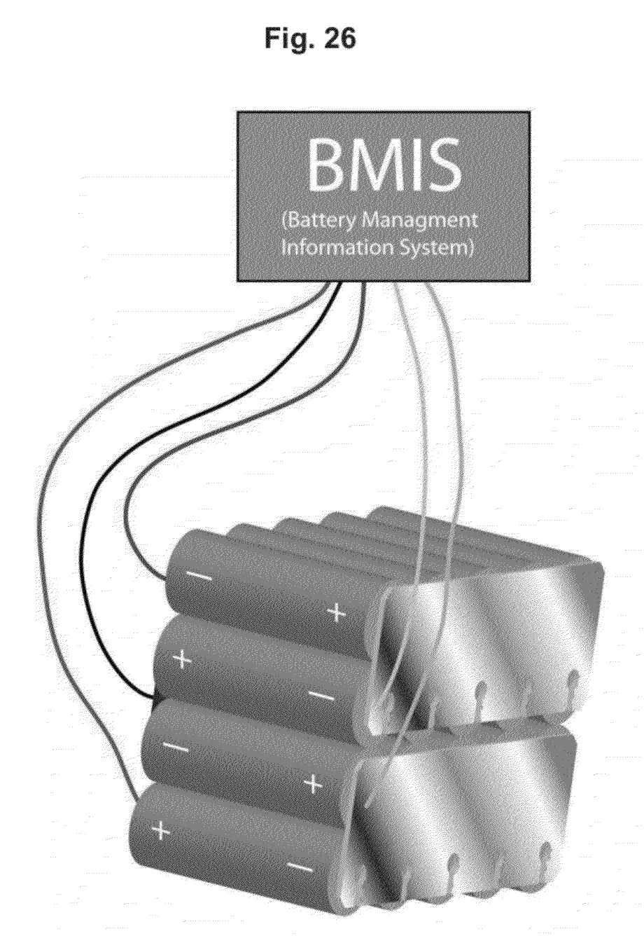

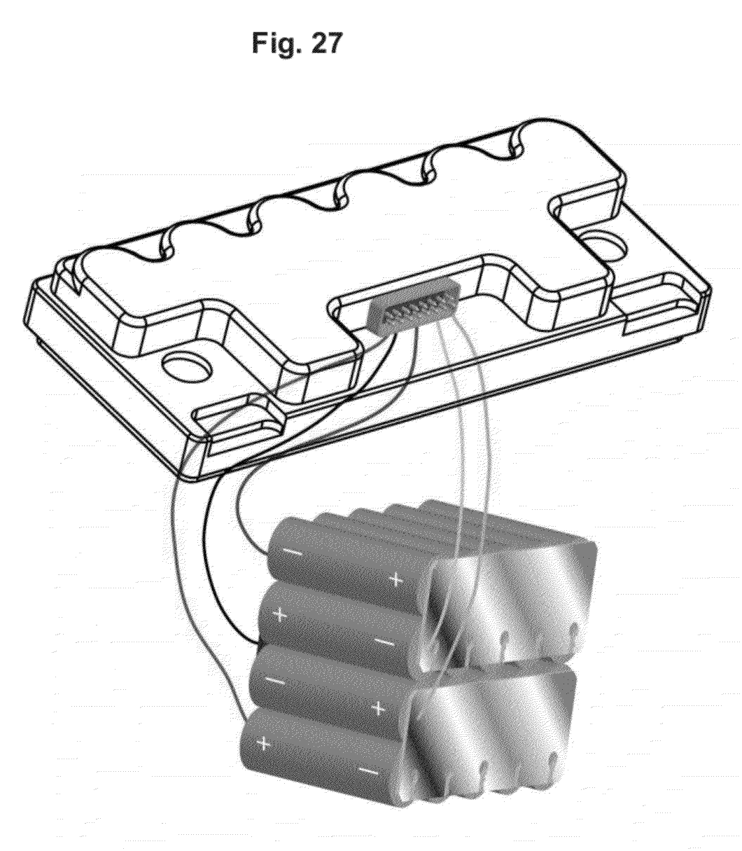

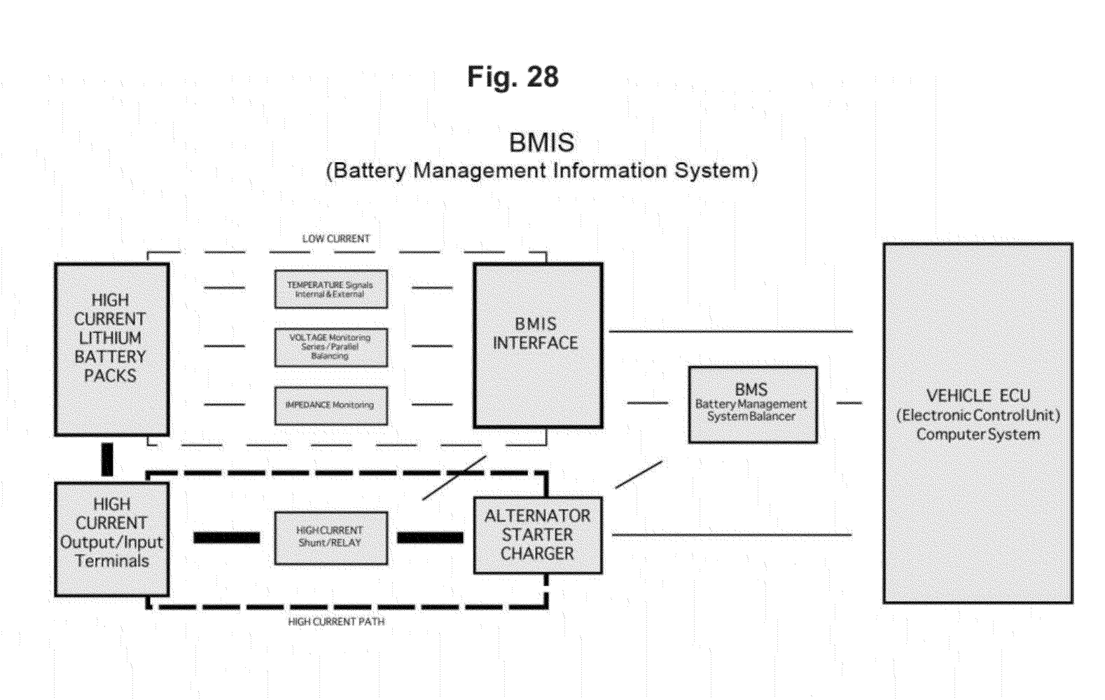

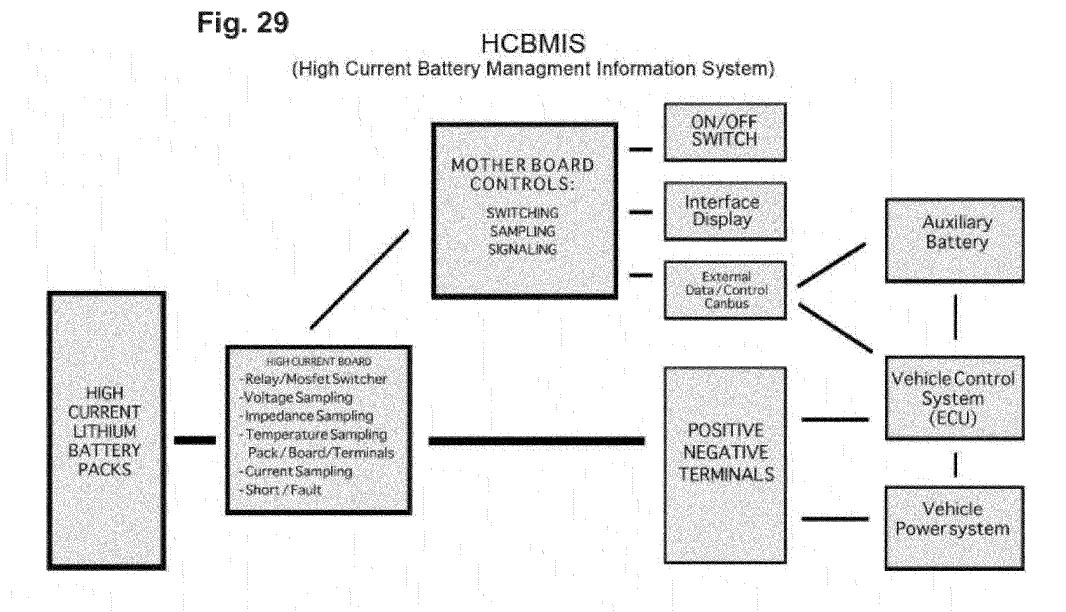

As shown in FIGS. 23 and 24, the connector 40 may be connected to a plurality of electrical connectors 54 within the battery unit 10. FIG. 24 also depicts an additional embodiment in accordance with the teachings of the present disclosure. The mounting bushing 69 may be configured to mount under the lid 16, so that the only external component is the terminal post 58. Additionally, a debris ring 74 may also be used to assist in sealing and securing the unit 10.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A lithium battery pack comprising:
a plurality of high rate lithium battery cells, each battery cell including opposing ends with positive and negative terminals, the negative terminal including a venting device, the plurality of battery cells being positioned adjacent to one another in a series of rows, the series of rows including first and second outer rows, and a plurality of inner rows, the adjacent cells of each row are positioned such that the positive terminals of each battery cell are in alignment and the negative terminals of each battery cell are in alignment;
an adhesively mounted electrical insulator mounted to the plurality of high rate lithium battery cells, the insulator comprising a plurality of substantially circular-shaped members configured to interconnect with the plurality of high rate lithium battery cells;
a negative terminal connecting strip connected via a direct contact to the aligned negative terminals of the first outer row, the negative terminal connecting strip comprising a single sheet of alloy material and a plurality of holes configured to be positioned in alignment with the venting devices of the first outer row;
a positive terminal connecting strip connected via a direct contact to the aligned positive terminals of the second outer row, the positive terminal connecting strip comprising a single sheet of alloy material; and
a plurality of cross-member connecting strips connected via a direct contact to two adjacent rows of cells such that the cross-member connecting strip connects a row of positive terminals and an adjacent row of negative terminals, wherein each cross-member connecting strip comprises a single sheet of alloy material and a plurality of key hole slots configured to be positioned in alignment with the venting devices of negative terminals;
wherein the negative terminal alloy connecting strip, positive terminal alloy connecting strip, and plurality of alloy cross-member connecting strips join the plurality of high rate lithium cells in both parallel and series.

2. A battery pack comprising:
a plurality of battery cells being positioned adjacent to one another in a series of rows including a first row and a second row;
a first endcap strip connected to the first row;
a second endcap strip connected to the second row; and
a plurality of cross-member strips connected to adjacent rows, wherein the first endcap, second endcap, and plurality of cross-member strips join the plurality of battery cells in both parallel and series.

3. The pack of claim 2 wherein the battery cells are high-rate lithium battery cells.

4. The pack of claim 3 wherein the first row and second row are outer rows.

5. The pack of claim 2 wherein each battery cell includes a venting device.

6. The pack of claim 5 wherein the first endcap includes a plurality of holes.

7. The pack of claim 5 wherein the cross-member strips include a plurality of holes.

8. The pack of claim 7 wherein the holes are key hole slots.

9. The pack of claim 2 further comprising an electrical insulator.

10. The pack of claim 9 wherein the electrical insulator is adhesively mounted to the pack.

11. The pack of claim 9 wherein the electrical insulator comprises a plurality of substantially circular-shaped members.

12. The pack of claim 2 wherein the first endcap is attached to the cells via direct contact.

13. The pack of claim 12 wherein the direct contact is a weld.

14. The pack of claim 13 wherein the weld includes at least eight weld points.

15. The pack of claim 2 wherein a cross-member strip is connected via a weld.

16. The pack of claim 2 wherein the plurality of battery cells comprises twenty battery cells, wherein the series of rows comprises four rows, each row including five battery cells.

17. A method of manufacturing a battery pack, the method comprising the following steps:
arranging a plurality of battery cells in a series of rows, the series of rows including first and second outer rows, adjacent cells within each row positioned such that positive terminals of each battery cell are aligned, adjacent rows positioned such that the positive terminals of a row are adjacent the negative terminals of the adjacent row;
applying an electrical insulator to the plurality of battery cells;
adhering a plurality of strips to the battery cells wherein the plurality of strips includes a first endcap and a second endcap whereby the plurality of cells is joined in both parallel and series.

18. The method of claim 17 wherein the electrical insulator holds the battery cells in place while the plurality of strips are adhered to the battery cells.

19. The method of claim 17 wherein adhering includes the step of welding the plurality of strips to the battery cells.

20. The method of claim 19 wherein the welding step comprises at least eight weld points for each battery cell.
